(19) United States
(12) Patent Application Publication
(10) Pub. No.: US 2025/0323538 A1
(43) Pub. Date: Oct. 16, 2025

(54) ELECTRIC MOTOR

(71) Applicant: Shigehiro HAGIWARA, Tatsuno-shi, Hyogo (JP)

(72) Inventors: Shigehiro HAGIWARA, Tatsuno-shi (JP); Hatsune HAGIWARA, Tatsuno-shi (JP); Koudai HAGIWARA, Tatsuno-shi (JP)

(21) Appl. No.: 18/720,542

(22) PCT Filed: Dec. 19, 2022
(86) PCT No.: PCT/JP2022/046726

§ 371 Date: Nov. 12, 2024

(30) Foreign Application Priority Data
Dec. 17, 2021 (JP) 2021-204781

(51) Int. Cl. H02K 1/06; H02K 3/28

(52) U.S. Cl. CPC H02K 1/06; H02K 3/28

(57) ABSTRACT

An electric motor according to the present invention includes: a first element forming a helix angle with a line extending in a circumferential direction of an annular body, the first element being wound on the annular body without being turned back in the circumferential direction; and a second element located in association with the first element to make an electromagnetic interaction with the first element to generate an electromagnetic force or a magnetic force acting in the circumferential direction of the annular body. One of the first and second elements constitutes at least a part of a stator of the electric motor, and the other of the first and second elements constitutes at least a part of a rotor of the electric motor, the rotor being rotatable by the electromagnetic force or the magnetic force in the circumferential direction of the annular body.

### TECHNICAL FIELD

The present invention relates to electric motors.

### BACKGROUND ART

For example, an electric motor as proposed in Patent Literature 1 is conventionally known.

Patent Literature 1 discloses an electric motor including a helically-wound sheet coil including a helically-wound conductive wire. The helically-wound sheet coil includes: a coil side portion including first and second conductive portions alternately inserted into a plurality of slots of a stator core; and a coil end portion integral with the coil side portion and connecting the ends of the first and second conductive portions that face in the same direction. The coil side portion extends straight in a direction substantially orthogonal to the moving direction of a mover magnetic pole and includes two layers arranged in the thickness direction of the helically-wound sheet coil. The coil end portion connects the first conductive portions of one of the two layers to the second conductive portions of the other layer in the direction of wave winding and connects the first conductive portions of the other layer to the second conductive portions of the one layer in the direction of wave winding, thus forming a coil element.

### CITATION LIST

### Patent Literature

PTL 1: Japanese Laid-Open Patent Application Publication No. 2013-128366

### SUMMARY OF INVENTION

### Technical Problem

In Patent Literature 1, the helically-wound coil side portion is turned back at the coil end portion, and this causes a reduction in energy efficiency.

It is therefore an object of the present invention to provide an electric motor that can operate with high energy efficiency.

### Solution to Problem

To solve the problem described above, an electric motor according to one embodiment of the present invention includes: a first element forming a helix angle with a line extending in a circumferential direction of an annular body, the first element being wound on the annular body without being turned back in the circumferential direction; and a second element located in association with the first element to make an electromagnetic interaction with the first element to generate an electromagnetic force or a magnetic force acting in the circumferential direction of the annular body, wherein one of the first and second elements constitutes at least a part of a stator of the electric motor, and the other of the first and second elements constitutes at least a part of a rotor of the electric motor, the rotor being rotatable by the electromagnetic force or the magnetic force in the circumferential direction of the annular body.

### Advantageous Effects of Invention

The present invention can provide an electric motor that can operate with high energy efficiency.

### BRIEF DESCRIPTION OF DRAWINGS

FIG. 1A is a schematic view showing an annular body of an electric motor according to a first embodiment of the present invention.

FIG. 1B is a schematic cross-sectional view showing an example of a coil included in a conventional electric motor and wound in an apparently close-packed pattern.

FIG. 1C is a schematic cross-sectional view showing a region of the conventional electric motor where the percentage of area occupied by the coil of FIG. 1B wound in an apparently close-packed pattern is low.

FIG. 1D is a schematic view showing a first example of a coil included in the electric motor according to the present invention and wound in a close-packed pattern.

FIG. 1E is a schematic view showing a second example of the coil included in the electric motor according to the present invention and wound in a close-packed pattern.

FIG. 1F is a schematic view showing a third example of the coil included in the electric motor according to the present invention and wound in a close-packed pattern.

FIG. 1G is a schematic view showing one embodiment of the electric motor according to the present invention, and the electric motor of this embodiment includes a plurality of structures aligned in the direction of the rotational axis.

FIGS. 1Ha to 1Hc show views for describing the top structure of the one embodiment of the electric motor of FIG. 1G; FIG. 1Ha is a perspective view of the top structure of the electric motor of FIG. 1G, FIG. 1Hb is a cross-sectional view along the line IHb-IHb of FIG. 1Ha, and FIG. 1Hc is a cross-sectional view along the line IHc-IHc of FIG. 1Ha.

FIG. 2 is a schematic view showing an electric motor according to the first embodiment of the present invention.

FIG. 3 is a schematic view showing the internal configuration of the electric motor according to the first embodiment of the present invention.

FIG. 4 is a schematic view showing an electric motor according to a second embodiment of the present invention.

FIG. 5 is a schematic view showing an electric motor according to a third embodiment of the present invention.

FIGS. 6A and 6B are schematic views showing an electric motor according to a fourth embodiment of the present invention; FIG. 6A is a plan view and FIG. 6B is a side view.

FIG. 7 is an external perspective view showing an electric motor according to a fifth embodiment of the present invention.

FIG. 8 is an external perspective view showing a ferromagnet segment included in the electric motor according to the fifth embodiment of the present invention and a permanent magnet fixed to the ferromagnet segment.

FIGS. 9A to 9C are schematic views for describing an electromagnetic interaction which occurs in the electric motor according to the fifth embodiment of the present invention; FIG. 9A shows a state where no AC voltage has been applied to a conductive wire, FIG. 9B shows a first magnetized state resulting from AC voltage application to the conductive wire, and FIG. 9C shows a second magnetized state resulting from AC voltage application to the conductive wire.

FIG. 10 is an external perspective view showing an electric motor according to a sixth embodiment of the present invention.

FIG. 11 is a schematic view in which some permanent magnets are omitted to show the internal configuration of the electric motor according to the sixth embodiment of the present invention.

FIG. 12 is an external perspective view showing an electric motor according to a seventh embodiment of the present invention.

FIG. 13 is a schematic view in which permanent magnets are omitted to show the internal configuration of the electric motor according to the seventh embodiment of the present invention.

FIG. 14 is an external perspective view which shows an electric motor according to an eighth embodiment of the present invention and in which permanent magnets are omitted.

FIG. 15 is an external perspective view showing an electric motor according to a ninth embodiment of the present invention.

FIG. 16 is a plan view showing the electric motor according to the ninth embodiment of the present invention.

FIG. 17 is an external perspective view showing a coil included in the electric motor according to the ninth embodiment of the present invention.

FIG. 18 is an enlarged view of a region of the electric motor according to the ninth embodiment of the present invention, the region being a region XVIII indicated in FIG. 17.

### DESCRIPTION OF EMBODIMENTS

Hereinafter, electric motors according to exemplary embodiments of the present invention will be described with reference to the drawings. The present invention is not limited by these embodiments. In the following description, the same or like elements are denoted by the same reference signs throughout the drawings and are not described repeatedly.

### (Basic Concept of Present Invention)

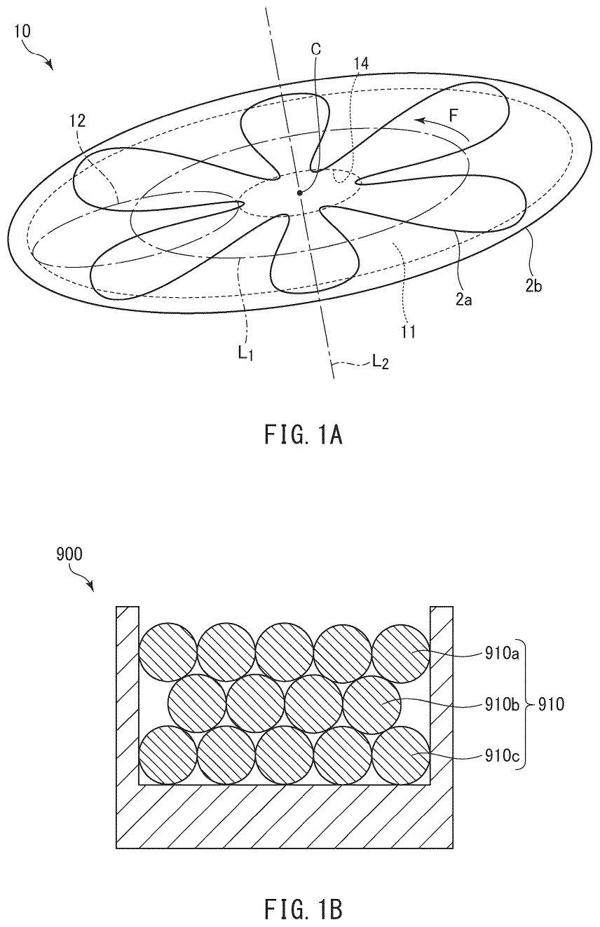

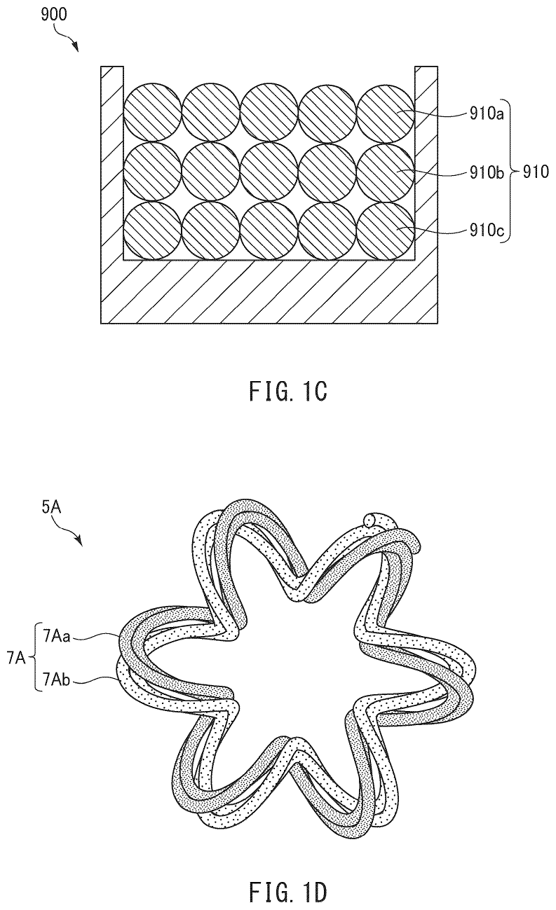

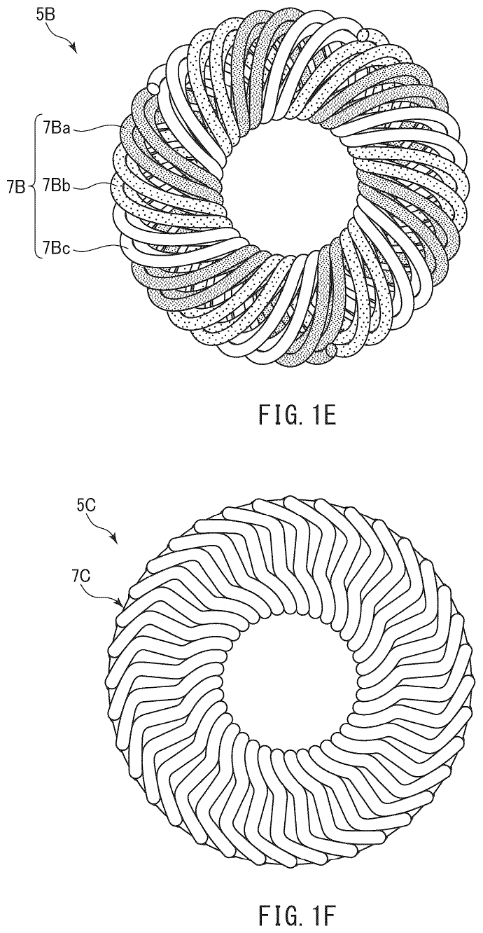

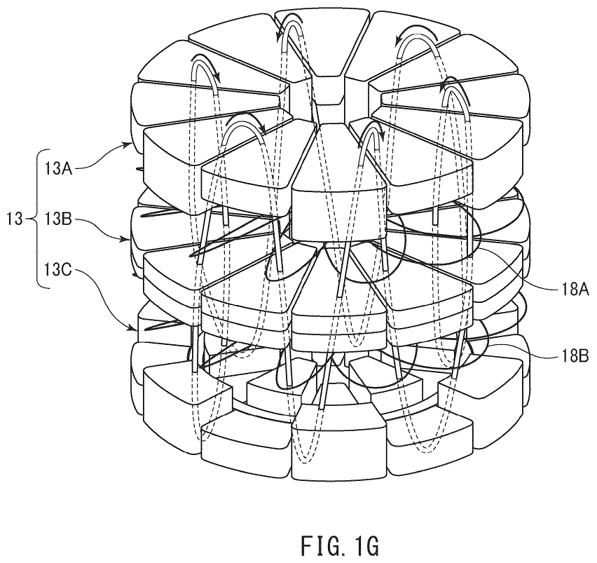

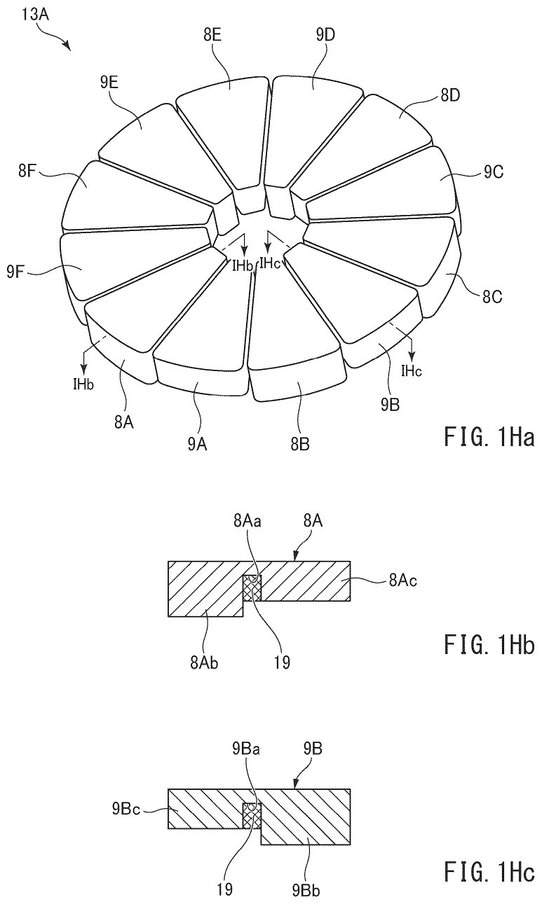

First, the basic concept of an electric motor according to the present invention will be described with reference to FIGS. 1A to 1H. FIG. 1A is a schematic view for describing the basic concept of the electric motor according to the present invention. As shown in FIG. 1A, the electric motor 10 according to the present invention includes: a first element 2a forming a helix angle with a line L₁ extending in the circumferential direction of an annular body 11, the first element 2a being wound on the annular body 11 without being turned back in the circumferential direction; and a second element 2b located in association with the first element 2a to make an electromagnetic interaction with the first element 2a to generate an electromagnetic force F or a magnetic force F acting in the circumferential direction of the annular body 11. One of the first and second elements 2a and 2b constitutes at least a part of a stator of the electric motor 10, and the other of the first and second elements 2a and 2b constitutes at least a part of a rotor of the electric motor 10, the rotor being rotatable by the electromagnetic force F or the magnetic force F in the circumferential direction of the annular body 11.

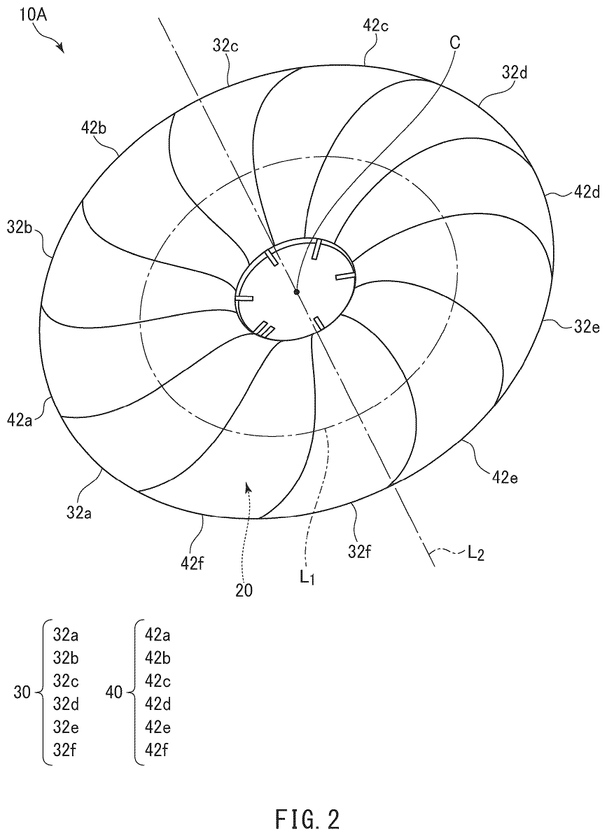

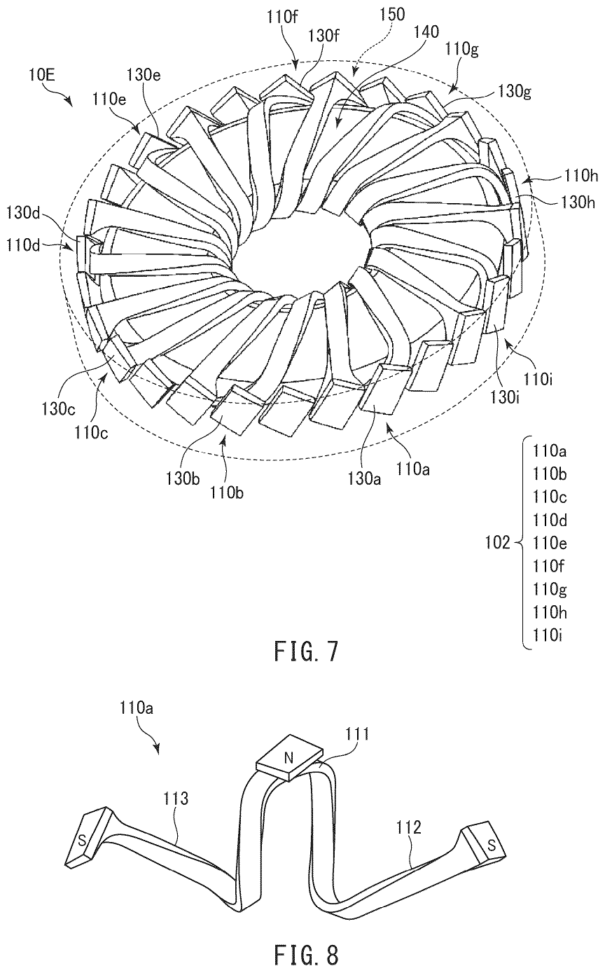

Assuming that there are a flat oval 12 and a central axis L₂ which, as shown in FIG. 1A, are on the same plane and do not intersect each other, the annular body 11 in the present invention is a solid obtained by rotating the oval 12 about the central axis L₂. The annular body 11 is not limited to having the shape as shown in FIG. 1A and may be any solid in which the geometric figure defined by the inner circumference of the annular body 11 and the geometric figure defined by the outer circumference of the annular body 11 are concentric when viewed along the central axis L₂. Each of the geometric figures may be a true circle or a geometric figure other than a true circle. Examples of the geometric figure other than a true circle include an ellipse and a polygon. To increase the circumferential length over which the force F acts, the oval 12 may have, for example, a shape with a negative curvature, a shape with a recess or projection, or a wavy shape. In FIG. 1A, the annular body 11 is depicted by a dashed line. There may be no element corresponding to the annular body 11 as in the embodiments described later with reference to FIGS. 2 to 6, or there may be an element corresponding to the annular body 11 as in the embodiment described later with reference to FIGS. 7 to 9.

Next, comparison of a conventional electric motor 900 and the electric motor 10 according to the present invention will be discussed with reference to FIGS. 1B to 1G. FIG. 1B is a schematic cross-sectional view showing an example of a coil included in the conventional electric motor and wound in an apparently close-packed pattern. FIG. 1C is a schematic cross-sectional view showing a region where the percentage of area occupied by the coil is low. FIGS. 1B and 1C are cross-sectional views of the electric motor 900 including a coil 910 wound in a manner called bank winding, and the cross-sectional views are taken at different portions of the electric motor 900.

In FIG. 1B, coil segments 910a (five coil segments located at the top of the figure and aligned in the left-right direction of the figure) and coil segments 910c (four coil segments located at the middle in the up-down direction of the figure and aligned in the left-right direction of the figure) are at the same locations in the left-right direction of the figure. In the figure, coil segments 910b (five coil segments located at the bottom of the figure and aligned in the left-right direction of the figure) are located between the coil segments 910a and 910c in the left-right direction of the figure. Due to such an arrangement, in the region of the electric motor 900 which is shown in FIG. 1B, the coil segments 910b reside in gaps arising from the fact that the coil segments 910a and 910c are round. Thus, in the region shown, the coil 910 is wound relatively densely.

In FIG. 1C, all of the coil segments 910a, 910b, and 910c are at the same locations in the left-right direction of the figure. Due to such an arrangement, in the region of the electric motor 900 which is shown in FIG. 1C, the coil segments 910b do not reside in gaps arising from the fact that the coil segments 910a and 910c are round. Thus, in the region shown, the coil 910 is wound less densely than in the region shown in FIG. 1B. The conventional electric motor 900, where the coil 910 is wound in multiple layers, has portions at which the coil 910 is turned back. Thus, the conventional electric motor 900 inevitably has a region as shown in FIG. 1C where the coil is coarsely wound. In the conventional electric motor 900, the coil is wound in an apparently close-packed pattern involving a region where the coil segments are not closely packed in a strict sense.

The conventional electric motor 900, where the coil 910 is wound in multiple layers in an apparently close-packed pattern as described above, suffers from non-uniformity of proximity effect or electrostatic field. Furthermore, due to the gaps between the coil segments 910a, 910b, and 910c and spring back which occurs during a bending process, the percentage of area occupied by the coil 910 declines at ends where the coil segments cannot be aligned with each other (for example, the three coil segments 910a, 910b, and 910c located at the right end in FIG. 1B and the three coil segments 910a, 910b, and 910c located at the left end in FIG. 1B) and in the region of the coil 910 which is shown in FIG. 1C and the vicinity of the region shown in FIG. 1C. The electric motor 900 suffers from a decline in the percentage of area occupied by the coil 910 also when, for example, the electric motor 900 has a configuration in which the coil 910 is inserted into slots. Additionally, there is a need for a space for passage of a non-closely-packed portion where the coil segments are not aligned with each other, and this poses an obstacle to reducing the overall size of the electric motor 900.

In contrast, a coil of the electric motor according to the present invention, which is shown in FIG. 1D or 1E, does not cause the above problems suffered by the conventional electric motor 900. FIG. 1D is a schematic view showing a first example of the coil included in the electric motor according to the present invention and wound in a close-packed pattern. FIG. 1E is a schematic view showing a second example of the coil. In FIGS. 1D and 1E, the elements of electric motors 5A and 5B that are other than coils 7A and 7B (elements such as a permanent magnet, a ferromagnet, and a housing) are omitted.

As shown in FIG. 1D, the coil 7A of the electric motor 5A according to the present invention includes a coil 7Aa wound on the annular body 11 described with reference to FIG. 1A without being turned back in the circumferential direction of the annular body 11, the coil 7Aa making two loops around the annular body 11 in the circumferential direction of the annular body 11 and being wound six turns per loop around a line extending in the circumferential direction of the annular body 11. The coil 7A further includes a coil 7Ab wound in the same manner as the coil 7Aa. The coils 7Aa and 7Ab are slightly displaced from each other in the circumferential direction of the annular body 11 and parallel to each other.

As shown in FIG. 1E, the coil 7B of the electric motor 5B according to the present invention includes a coil 7Ba wound on the annular body 11 described with reference to FIG. 1A without being turned back in the circumferential direction of the annular body 11, the coil 7Ba making four loops around the annular body 11 in the circumferential direction of the annular body 11 and being wound six turns per loop around a line extending in the circumferential direction of the annular body 11. The coil 7B further includes coils 7Bb and 7Bc wound in the same manner as the coil 7Ba. The coils 7Ba, 7Bb, and 7Bc are slightly displaced from each other in the circumferential direction of the annular body 11 and parallel to each other.

In the above-described electric motor 5A or 5B according to the present invention, the multipole coil 7A or 7B is wound in multiple layers and takes a form which resembles a torus knot in knot theory in topology and in which coil segments of the different layers are at substantially the same locations in the left-right direction. Thus, the coil 7A or 7B of the electric motor 5A or 5 B according to the present invention is wound in a close-packed parallel pattern rather than being wound in an apparently close-packed pattern like the coil 910 of the conventional electric motor 900 described above. As such, the electric motors 5A and 5B according to the present invention can solve the above-described problems occurring in the conventional electric motor 900.

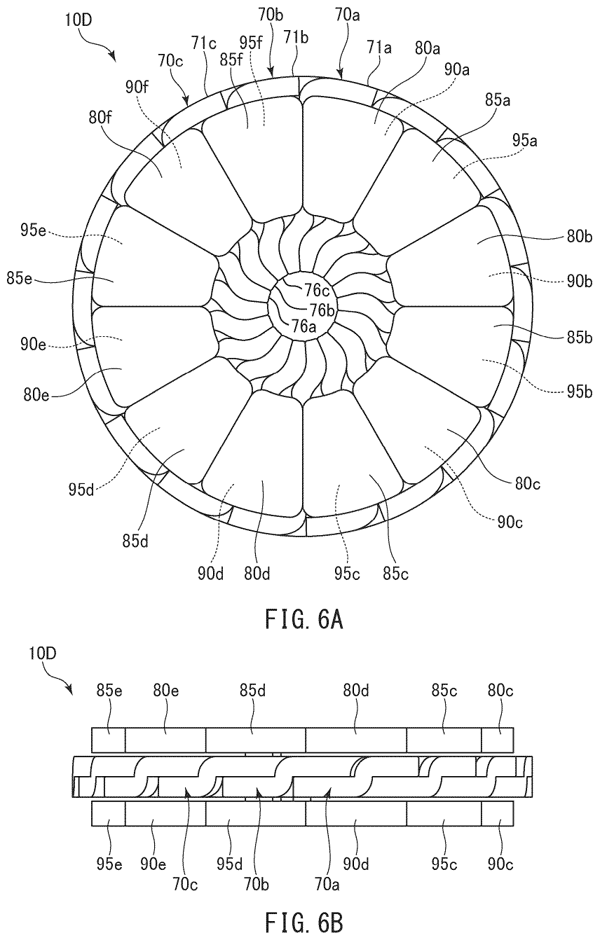

FIG. 1F is a schematic view showing a third example of the coil included in the electric motor according to the present invention and wound in a close-packed pattern. As shown in FIG. 1F, the electric motor 5C according to the present invention includes a coil 7C wound along a cycloid curve. Being wound along a cycloid curve, the coil 7C can be wound in a close-packed pattern at regular pitches without wasted space. Although in the electric motor 5C the coil 7C is wound along a cycloid curve, the portions of the coil 7C that face unshown, flat permanent magnets located outside the coil 7C are straight when viewed in the axial direction of the shaft hole of the coil 7C (when viewed as in FIG. 1F). Specifically, the permanent magnets are disposed as shown in FIG. 6 which will be referred to later.

The coil 7C of the electric motor 5C may have a larger inner diameter and a larger outer diameter in the course of production (in particular, during winding of the coil 7C) than after the production of the electric motor 5C as shown in FIG. 1F has been completed. When the inner diameter is kept large during winding of the coil 7C, it is easy to pass tools through the shaft hole of the coil. This way of producing the electric motor 5C makes it easier to wind the coil 7C in a close-packed pattern. After the end of winding of the coil 7C, a radially inward external force is applied to the coil 7C, and thus the completed electric motor 5C as shown in FIG. 1F can be obtained in which the percentage of area occupied by the coil 7C is high. The above way of production allows for easy production of the electric motor 5C that is compact in size. Further, for example, keeping the inner diameter large during winding of the coil 7C facilitates formation of an insulation coating. After the insulation coating formation, the coil 7C can be formed into the same shape as the first element 2a wound on the annular body 11 described with reference to FIG. 1A.

When the present invention is applied to an axial gap motor, winding a permanent magnet on the annular body 11 described with reference to FIG. 1A offers another advantage. For example, as shown in FIG. 1G, a plurality of electric motors may be stacked on top of each other in the up-down direction, and this can provide a long magnetic path. FIG. 1G is a schematic view showing an embodiment of the electric motor according to the present invention. In this embodiment, a plurality of electric motors are aligned in the direction of the rotational axis. The electric motor 13 of FIG. 1G includes two electric motors stacked on top of each other in the up-down direction. The electric motor 13 includes a top structure 13A, a middle structure 13B, and a bottom structure 13C. The electric motor 13 further includes a coil 18A located between the top structure 13A and the middle structure 13B and a coil 18B located between the middle structure 13B and the bottom structure 13C. The coils 18A and 18B have the same size and shape. Each of the coils 18A and 18B corresponds to the first element 2a described with reference to FIG. 1A which forms a helix angle with a line L₁ extending in the circumferential direction of the annular body 11 and which is wound on the annular body 11 without being turned back in the circumferential direction. A first electric motor is constructed of the top structure 13A, the middle structure 13B, and the coil 18A, and a second electric motor is constructed of the middle structure 13B, the bottom structure 13C, and the coil 18B.

FIGS. 1Ha to 1Hc show views for describing the top structure of one embodiment of the electric motor of FIG. 1G. FIG. 1Ha is a perspective view of the top structure of the electric motor of FIG. 1G, FIG. 1Hb is a cross-sectional view along the line IHb-IHb of FIG. 1Ha, and FIG. 1Hc is a cross-sectional view along the line IHc-IHc of FIG. 1Ha.

The top structure 13A includes an annular coil 19 and ferromagnets 8A to 8F and 9A to 9F located in association with the coil 19 to make an electromagnetic interaction with the coil 19 to generate an electromagnetic force acting in the circumferential direction of the annular body 11 described with reference to FIG. 1A (electromagnetic force acting in the rotational direction of the electric motor 13 to drive the electric motor 13). The ferromagnets 8A to 8F have the same structure. The ferromagnets 9A to 9F have the same structure. The ferromagnets 9A to 9F as viewed in plan have the same shape as the ferromagnets 8A to 8F.

As shown in FIG. 1Ha, each of the ferromagnets 8A to 8F and 9A to 9F as viewed in plan has a width that increases with distance from the rotational axis of the electric motor 13. Thus, the ferromagnets 8A to 8F and 9A to 9F are arranged side by side around the rotational axis of the electric motor 13. The ferromagnet 9A is located between the ferromagnets 8A and 8B. The ferromagnet 9B is located between the ferromagnets 8B and 8C. The ferromagnet 9C is located between the ferromagnets 8C and 8D. The ferromagnet 9D is located between the ferromagnets 8D and 8E. The ferromagnet 9E is located between the ferromagnets 8E and 8F. The ferromagnet 9F is located between the ferromagnets 8F and 8A.

As shown in FIG. 1Hb, the ferromagnet 8A is flat and includes: a recess 8Aa into which the coil 19 is fitted; and a projection 8Ab located at the end of the ferromagnet 8A remote from the rotational axis of the electric motor 13, the projection 8Ab extending downward in the direction of the rotational axis. The ferromagnet 8A has a north pole on the lower end of the projection 8Ab and a south pole on the end 8Ac close to the rotational axis of the coil 19. FIG. 1Hb shows the ferromagnet 8A the whole of which is formed as a single piece. The ferromagnet 8A is not limited to this form, and the projection 8Ab and the rest of the ferromagnet 8A may be formed separately. As mentioned above, the ferromagnets 8A to 8F have the same structure. Thus, the description as given for the ferromagnet 8A applies to the ferromagnets 8B to 8F and will not be repeated.

As shown in FIG. 1Hc, the ferromagnet 9B is flat and includes: a recess 9Ba into which the coil 19 is fitted; and a projection 9Bb located at the end of the ferromagnet 9B close to the rotational axis of the electric motor 13, the projection 9Bb extending downward in the direction of the rotational axis. The ferromagnet 9B has a south pole on the lower end of the projection 9Bb and a north pole on the end 9Bc remote from the rotational axis of the coil 19. FIG. 1Hc shows the ferromagnet 9A the whole of which is formed as a single piece. The ferromagnet 9A is not limited to this form, and the projection 9Bb and the rest of the ferromagnet 9A may be formed separately. As mentioned above, the ferromagnets 9A to 9F have the same structure. Thus, the description as given for the ferromagnet 9B applies to the ferromagnets 9A and 9C to 9F and will not be repeated.

As shown in FIG. 1G, the middle structure 13B includes 12 flat ferromagnets (or permanent magnets) in one-to-one correspondence with the ferromagnets 8A to 8F and 9A to 9F of the top structure 13A described above. The 12 ferromagnets as viewed in the direction of the rotational axis of the electric motor 13 have the same outer shape as the ferromagnets 8A to 8F and 9A to 9F of the top structure 13A described above. Six ferromagnets of the 12 ferromagnets which are in one-to-one correspondence with the ferromagnets 8A to 8F of the top structure 13A described above are disposed to have south poles on their surfaces facing the ferromagnets 8A to 8F. The other six ferromagnets of the 12 ferromagnets, which are in one-to-one correspondence with the ferromagnets 9A to 9F of the top structure 13A described above, are disposed to have north poles on their surfaces facing the ferromagnets 9A to 9F.

As shown in FIG. 1G, the bottom structure 13C is substantially symmetric to the above-described top structure 13A with respect to a plane including the center of the electric motor 13 in the direction of the rotational axis and orthogonal to the rotational axis. Thus, the description as given for the top structure 13A applies to the bottom structure 13C and will not be repeated. The 12 ferromagnets of the bottom structure 13C are disposed such that the magnetic poles of each of them are opposite to those of a corresponding one of the ferromagnets 8A to 8F and 9A to 9F described above.

In the electric motor 13 having the configuration as described above, the magnetic path depicted by dashed lines etc. in FIG. 1G is turned back a number of times at the opposite ends of the electric motor 13 in the up-down direction in a manner as schematically shown by arrows depicted near the upper surface of the top structure 13A. Thus, the magnetic path is long. With such a long magnetic path, parameters such as Nagaoka coefficient, permeance coefficient, and L/D ratio can have desired values. This can lead to various advantageous effects. Since, as described above, the magnetic path is turned back at the opposite ends in the up-down direction, the magnetic force can be enhanced in an inner region of the electric motor 13, while the magnetic force can be lessened in an outer region of the electric motor 13. This makes it possible to increase the output power of the electric motor 13 and at the same time prevent leak of the magnetic force to the outside of the electric motor 13.

A variant of the electric motor 13 of FIG. 1G may be one in which the ferromagnets 8A to 8F and 9A to 9F described above are permanent magnets that generate alternating magnetic fields and in which a magnetic path is formed by connecting the south pole of each permanent magnet to the north pole of another adjacent permanent magnet by means of a back yoke. An electric motor with such a configuration can provide the same advantages as the electric motor 13 described with reference to FIG. 1G.

Another variant of the electric motor 13 of the FIG. 1G may be one in which he ferromagnets 8A to 8F and 9A to 9F described above are permanent magnets that generate alternating magnetic fields and in which a magnetic path is formed by placing an additional permanent magnet between the south pole of each permanent magnet and the north pole of another adjacent permanent magnet so as to create a Halbach array. An electric motor with such a configuration can provide the same advantages as the electric motor 13 described with reference to FIG. 1G.

When a Halbach array is used as mentioned above, for example, the 12 ferromagnets of the middle structure 13B described with reference to FIG. 1G are permanent magnets, and each of the 12 permanent magnets is divided into five permanent magnets (that is, a total of 60 permanent magnets are used). The five permanent magnets are flat and have the same thickness. Each of the five permanent magnets has a width that increases with distance from the rotational axis of the electric motor. The five permanent magnets are arranged in two layers in the direction of the rotational axis of the electric motor. Two of the five permanent magnets form a first layer, and the other three permanent magnets form a second layer, the first layer being axially inside the second layer in the electric motor. The overall shape and size of the combination of the two permanent magnets of the first layer are substantially the same as the overall shape and size of the combination of the three permanent magnets of the second layer.

When the electric motor is viewed from a point radially outside an imaginary circle centered on the rotational axis of the electric motor, a magnetic field directed outward in the direction of the rotational axis of the electric motor is generated in one of the two permanent magnets of the first layer (this permanent magnet will be hereinafter referred to as the “first flat magnet”). In one of the three permanent magnets of the second layer that faces the first flat magnet (the one permanent magnet will be hereinafter referred to as the “second flat magnet”), a magnetic field is generated which is inclined in a direction from the first flat magnet of the electric motor toward the middle one of the three permanent magnets of the second layer (the middle permanent magnet will be hereinafter referred to as the “third flat magnet”). In the third flat magnet, a magnetic field is generated which is orthogonal to the direction of the rotational axis of the electric motor and directed toward the other one of the three permanent magnets of the second layer that is opposite from the second flat magnet (the other permanent magnet will be hereinafter referred to as the “fourth flat magnet”). In the fourth flat magnet, a magnetic field is generated which is inclined in a direction from the third flat magnet of the electric motor toward the other one of the two permanent magnets of the first layer (the other permanent magnet will be hereinafter referred to as the “fifth flat magnet”). In the fifth flat magnet, a magnetic field is generated which is directed inward in the direction of the rotational axis of the electric motor. When the structure described above is used in place of the top structure 13A and the bottom structure 13C of the electric motor 13 described with reference to FIG. 1G, advantages which are the same as those of the electric motor 13 described with reference to FIG. 1G can be achieved. The use of another structure employing a Halbach array can also provide the advantages which are the same as those of the electric motor 13 described with reference to FIG. 1G.

The electric motor according to the present invention can be used as a Faraday motor. Currently-known Faraday motors can only generate low voltage proportional to the radius of a disc-shaped conductor and have not yet been into practice. However, it is expected that in the future it will become possible to generate high electric power by unipolar induction using a magnetic line source and a conductor which are annularly wound so as to ensure a sufficient length of the conductor and a high voltage.

It is conceivable to operate the electric motor according to the present invention as a single-phase motor by establishing a proper positional relationship among waves with different frequencies, windings, and magnetic poles through optimization for allowing overlapping high-frequency waves to form a soliton wave (an example of the optimization is to wind one coil with 84 turns to allow waves with different frequency waves to overlap one another). Overlapping of wave crests results in a higher crest, overlapping of wave troughs results in a deeper trough, and overlapping of a wave crust and a wave trough results in wave cancellation. It is expected that the electric motor can operate as a single-phase motor when waves with different frequencies overlap each other in an appropriate manner such that waves each having 28 crests or 28 pairs of crests and troughs appear one after another every 14 turns of the total of 84 turns.

### First Embodiment

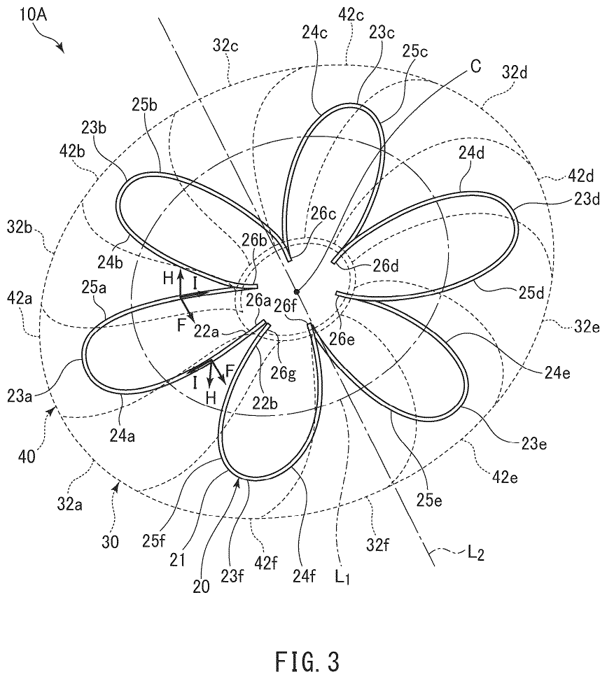

FIG. 2 is an external perspective view showing an electric motor according to a first embodiment of the present invention. FIG. 3 is a schematic view showing the internal configuration of the electric motor. In FIG. 3, permanent magnets 30 and 40 are depicted as transparent by dashed lines to show the internal configuration of the electric motor 10A.

### (Conductive Wire 20)

As shown in FIGS. 2 and 3, the electric motor 10A according to the present embodiment includes: a conductive wire 20 (one of the first and second elements) forming a helix angle with a line L₁ extending in the circumferential direction of the annular body 11 described with reference to FIG. 1A, the conductive wire 20 being wound on the annular body 11 without being turned back in the circumferential direction; and permanent magnets 30 and 40 (the other of the first and second elements) located in association with the conductive wire 20 to make an electromagnetic interaction with the conductive wire 20 to generate an electromagnetic force F acting in the circumferential direction of the annular body 11.

In the present embodiment, the electric motor 10A is configured as a DC motor. In the present embodiment, the conductive wire 20 constitutes at least a part of the rotor of the electric motor 10A, and the permanent magnets 30 and 40 constitute at least a part of the stator of the electric motor 10A. In the drawings, a rotating shaft extending along the central axis L₂ of the annular body 11 described with reference to FIG. 1A, a housing accommodating the conductive wire 20 and the permanent magnets 30 and 40, and bearings for mounting the rotating shaft to the housing are omitted for the sake of visibility. The same applies to electric motors 10B to 10I described later.

As shown in FIG. 3, the conductive wire 20 includes: a winding portion 21 (DC winding portion) making one loop around the annular body 11 described with reference to FIG. 1A in the circumferential direction of the annular body 11; seven extraction portions 26a to 26g (DC voltage application portions) located on the winding portion 21 at substantially regular intervals in the circumferential direction of the annular body 11 to apply a DC voltage to the electric motor 10A.

As shown in FIG. 3, the winding portion 21 includes a first end 22a facing a shaft hole 14 of the annular body 11 described with reference to FIG. 1A and a second end 22b facing the shaft hole 14 of the annular body 11 and adjacent to the first end 22a.

The winding portion 21 makes one loop from the first end 22a to the second end 22b around the annular body 11 described with reference to FIG. 1A without being turned back in the circumferential direction of the annular body 11. The winding portion 21, which makes such one loop around the annular body 11 in the circumferential direction of the annular body 11, is wound six turns on the annular body 11 without being turned back in the circumferential direction. That is, the conductive wire 20 is configured as a coil with six turns.

As shown in FIG. 3, the winding portion 21 includes: a first wound portion 23a extending from the first end 22a and wound one turn around the line L₁; a second wound portion 23b extending from the end of the first wound portion 23a opposite from the first end 22a and wound one turn around the line L₁; a third wound portion 23c extending from the end of the second wound portion 23b opposite from the first wound portion 23a and wound one turn around the line L₁; a fourth wound portion 23d extending from the end of the third wound portion 23c opposite from the second wound portion 23b and wound one turn around the line L₁; a fifth wound portion 23e extending from the end of the fourth wound portion 23d opposite from the third wound portion 23c and wound one turn around the line L₁; and a sixth wound portion 23f extending from the end of the fifth wound portion 23e opposite from the fourth wound portion 23d and wound one turn around the line L₁.

The extraction portion 26a projects from the first end 22a toward the center of the annular body 11 described with reference to FIG. 1A. The extraction portion 26b projects from the end of the first wound portion 23a opposite from the first end 22a toward the center of the annular body 11. The extraction portions 26c, 26d, 26e, and 26f are located on the second, third, fourth, and fifth wound portions 23b, 23c, 23d, and 23e, respectively, in the same manner as the extraction portion 26b is located on the first wound portion 23a. The extraction portion 26g is located at the second end 22b in the same manner as the extraction portion 26a is located at the first end 22a.

In the present embodiment, the conductive wire 20 includes first facing portions facing the permanent magnets 30 and 40, while the permanent magnets 30 and 40 include second facing portions facing the conductive wire 20. The first and second facing portions, as viewed in a direction orthogonal to the thickness direction of the annular body 11 described with reference to FIG. 1A, have curved shapes conforming to each other.

### (Permanent Magnets 30 and 40)

The permanent magnets 30 and 40 are combined together to enclose the conductive wire 20. The width direction of each of the permanent magnets 30 and 40 is substantially the same as the circumferential direction of the annular body 11 described with reference to FIG. 1A, and the thickness direction of each of the permanent magnets 30 and 40 (i.e., the thickness direction of the electric motor 10A) is substantially the same as the direction extending from the permanent magnet 30 or 40 itself toward the line L₁.

Each of the permanent magnets 30 and 40 forms a helix angle with the line L₁, is wound on the annular body 11 described with reference to FIG. 1A, and is located outside the conductive wire L. Each of the permanent magnets 30 and 40, just like the conductive wire 20, is wound six turns around the line L₁ and makes one loop around the annular body 11 in the circumferential direction of the annular body 11.

The permanent magnets 30 and 40, as viewed along the central axis L₂ of the annular body 11 described with reference to FIG. 1A, alternate with each other in the circumferential direction of the annular body 11. Each of the permanent magnets 30 and 40 has a width that increases with distance from the shaft hole 14 of the annular body 11. Thus, the interval between the permanent magnets 30 or 40 is substantially uniform at any location in the radial direction of the annular body 11.

In the present embodiment, the permanent magnet 30 is divided, every turn of winding, at its end facing the shaft hole 14 of the annular body 11 described with reference to FIG. 1A. That is, the permanent magnet 30 includes circumferentially arranged magnet segments 32a to 32f each of which is wound around the line L₁ and which have the same shape and size. Likewise, the permanent magnet 40 is divided, every turn of winding, at its end facing the shaft hole 14 of the annular body 11. That is, the permanent magnet 40 includes circumferentially arranged magnet segments 42a to 42f each of which is wound around the line L₁ and which have the same shape and size. The magnet segments 32a to 32f or the magnet segments 42a to 42f are not limited to having the same shape and size and may have different shapes and sizes.

The magnet segments 32a to 32f need not have the same shape or size. For example, if the rate at which the direction of a current I changes in accordance with the south and north poles could be insufficient during operation at high speed rotation, wide and narrow magnet segments may be used in combination as the magnet segments wound around the line L₁, and the combined use of wide and narrow magnet segments allows synchronization to the wide magnet segments to occur quickly enough.

The extraction portions 26a to 26g of the conductive wire 20 may project toward the center C of the annular body 11 from locations where the permanent magnet 30 is divided (i.e., from the end surfaces of the permanent magnet 30 that face the shaft hole 14 of the annular body 11 described with reference to FIG. 1A). Alternatively, the extraction portions 26a to 26g of the conductive wire 20 may project toward the center C of the annular body 11 from locations where the permanent magnet 40 is divided (i.e., from the end surfaces of the permanent magnet 40 that face the shaft hole 14 of the annular body 11).

The permanent magnet 30 has a north pole on its inner surface (one side in the thickness direction) and a south pole on its outer surface (the other side in the thickness direction). The permanent magnet 40 has a south pole on its inner surface and a north pole on its outer surface. In the internal space defined by the permanent magnets 30 and 40, the inner surfaces of the permanent magnets 30 and 40 face each other. Thus, in the internal space, a magnetic field H directed from the permanent magnet 30 toward the permanent magnet 40 is generated. The magnetic field H is orthogonal or substantially orthogonal to the line L₁.

In the present embodiment, a voltage is applied between the extraction portions 26a and 26b, with the extraction portion 26a serving as a positive pole and the extraction portion 26b serving as a negative pole, and the current I flows from the extraction portion 26a toward the extraction portion 26b in the first wound portion 23a. As shown in FIG. 3, in a front region 24a of the first wound portion 23a that extends from the first end 22a to the vicinity of a radially outermost point on the annular body 11 described with reference to FIG. 1A, the current I flows outward in the radial direction of the annular body 11, while in a back region 25a of the first wound portion 23a that extends from the vicinity of the radially outermost point to the end opposite from the first end 22a (i.e., the end from which the extraction portion 26b projects), the current I flows inward in the radial direction of the annular body 11.

As such, in the state of FIG. 2, the current I flowing outward in the radial direction of the annular body 11 in the front region 24a of the first wound portion 23a and the magnetic field H directed from the magnet segment 32a toward the magnet segment 42a (i.e., the magnetic field H directed from the side seen in FIG. 2 toward the side hidden in FIG. 2) electromagnetically interact with each other to generate an electromagnetic force F in the front region 24a, with the electromagnetic force F directed counterclockwise in the circumferential direction of the annular body 11 described with reference to FIG. 1A. Additionally, the current I flowing inward in the radial direction of the annular body 11 in the back region 25a of the first wound portion 23a and the magnetic field H directed from the magnet segment 32b toward the magnet segment 42b (i.e., the magnetic field H directed from the side hidden in FIG. 2 toward the side seen in FIG. 2) electromagnetically interact with each other to generate an electromagnetic force F in the back region 25a, with the electromagnetic force F directed counterclockwise in the circumferential direction of the annular body 11.

In the region where there are the magnet segments 32a and 42a and the magnet segments 32b and 42b, the electromagnetic forces F generated as described above in the first wound portion 23a cause the conductive wire 20 to rotate counterclockwise from the state of FIG. 2 in the circumferential direction of the annular body 11 described with reference to FIG. 1A. Once the first wound portion 23a reaches the region where there are the magnet segments 32f and 42f and the magnet segments 32e and 42e, counterclockwise electromagnetic forces F are generated in that region as in the region where there are the magnet segments 32a and 42a and the magnet segments 32b and 42b. Thus, the conductive wire 20 rotates counterclockwise in the circumferential direction of the annular body 11 also in the region where there are the magnet segments 32f and 42f and the magnet segments 32e and 42e. By repeating such a process, the conductive wire 20 can continue to rotate over the entire circumference of the annular body 11.

### Advantages of First Embodiment

In the present embodiment, the conductive wire 20 is wound on the annular body 11 described with reference to FIG. 1A without being turned back in the circumferential direction of the annular body 11. Thus, the electromagnetic interaction of the conductive wire 20 with the permanent magnets 30 and 40 can generate an electromagnetic force F over the entirety of the conductive wire 20. In a conventional motor where a conductive wire has a turned-back portion at which the conductive wire is turned back in the circumferential direction of an annular body, any electromagnetic interaction does not occur in the turned-back portion, in which no electromagnetic force is generated. Compared to such a conventional motor, the electric motor 10A according to the present embodiment can operate with high energy efficiency. Additionally, the electric motor 10A can offer the various advantages mentioned in relation to the basic concept described with reference to FIGS. 1A to 1H for the electric motor according to the present invention.

### Modifications to First Embodiment

In the present embodiment, an example has been described in which the conductive wire 20 is configured as a coil with six turns. This example is not limiting, and the conductive wire 20 may be configured as a coil with one to five turns or with seven or more turns. In the present embodiment, an example has been described in which the winding portion 21 makes only one loop in the circumferential direction of the annular body 11 described with reference to FIG. 1A. This example is not limiting, and the winding portion 21 may make two or more loops in the circumferential direction of the annular body 11 in such a manner that different portions of the winding portion 21 do not contact each other. Despite the conductive wire 20 being wound at a plurality of locations, connections can be established without using any jumper line, forming any joint, turning back the conductive wire 20, or causing different portions of the conductive wire 20 to intersect each other. Thus, for example, the conductive wire 20 may be in the form of a hollow conductor, through which a refrigerant can be made to flow efficiently.

In the present embodiment, an example has been described in which a voltage is applied between the extraction portions 26a and 26b and the current I flows from the extraction portion 26a toward the extraction portion 26b in the first wound portion 23a. This example is not limiting, and a voltage may be applied between any two of the extraction portions 26a to 26f. For example, a voltage may be applied between the extraction portions 26a and 26c, between the extraction portions 26a and 26d, between the extraction portions 26a and 26e, or between the extraction portions 26a and 26f.

In the present embodiment, an example has been described in which the conductive wire 20 includes seven extraction portions 26a to 26g. This example is not limiting and, for example, the conductive wire 20 may include two to six extraction portions or eight or more extraction portions. Alternatively, the end surfaces of the permanent magnets 30 and 40 which face the shaft hole 14 of the annular body 11 described with reference to FIG. 1A may be widened, and a part of a power source may be inserted into the internal space defined by the permanent magnets 30 and 40 to apply a voltage directly to the winding portion without intervention of any extraction portions.

In the present embodiment, an example has been described in which the conductive wire 20 constitutes at least a part of the rotor of the electric motor 10A, and the permanent magnets 30 and 40 constitute at least a part of the stator of the electric motor 10A. This example is not limiting, and the conductive wire 20 may constitute at least a part of the stator, and the permanent magnets 30 and 40 may constitute at least a part of the rotor.

In the present embodiment, an example has been described in which the permanent magnets 30 and 40 as shown in FIG. 2 are used as the other of the first and second elements. This example is not limiting, and conductors having the same shape and size as the permanent magnets 30 and 40 may be used in place of the permanent magnets 30 and 40. With such a configuration, the electric motor 10A can be operated on the same principle as an induction motor. When conductors are used in place of the permanent magnets 30 and 40, the conductors are not limited to having the same shape and size as the permanent magnets 30 and 40 and may have different shapes and sizes.

### Second Embodiment

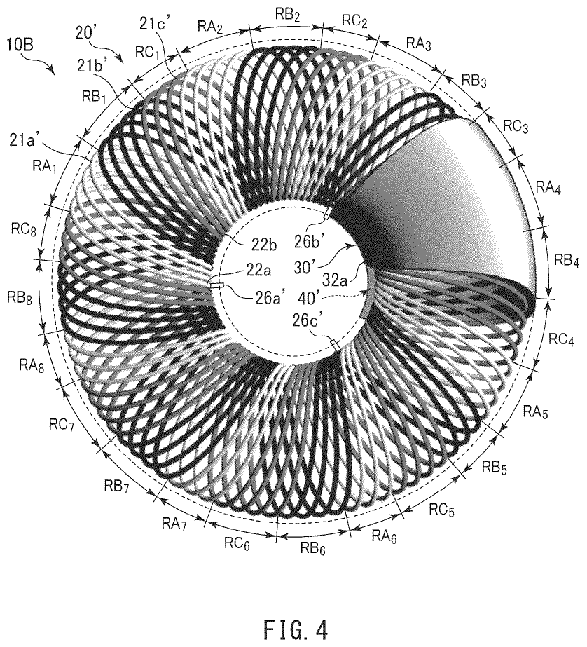

FIG. 4 is a schematic view showing an electric motor according to a second embodiment of the present invention. The electric motor 10B according to the present embodiment has the same configuration as the electric motor 10A described above, except that a conductive wire 20′ is different in configuration from the conductive wire 20, that a permanent magnet 30′ includes four magnet segments 32a to 32d, that a permanent magnet 40′ includes four magnet segments 42a to 42d, and that the electric motor 10B is configured as a three-phase AC motor. The components of the electric motor 10B that are identical to components of the electric motor 10A are denoted by the same reference signs as the components of the electric motor 10A, and descriptions as given above for such components will not be repeated. In FIG. 4, to illustrate the internal configuration of the electric motor 10B, only the magnet segment 32a is shown as a constituent of the permanent magnets 30′ and 40′, and the magnet segments 32b to 32d and magnet segments 42a to 42d are indicated only by their outer contours depicted by dashed lines.

The electric motor 10B according to the present embodiment includes a single conductive wire 20′. The conductive wire 20′ includes: winding portions 21a′ to 21c′ (AC winding portions) each of which makes three and five-eighths loops around the annular body 11 described with reference to FIG. 1A in the circumferential direction of the annular body 11; and extraction portions 26a′ to 26c′ (AC voltage application portions) located on the winding portions 21a′ to 21c′ to apply an AC voltage to the electric motor 10B. The extraction portion 26a′ is located at an end of the winding portion 21a′, the extraction portion 26b′ is located at an end of the winding portion 21b′, and the extraction portion 26c′ is located at an end of the winding portion 21c′.

The winding portion 21a′ has the first end 22a at which the extraction portion 26a′ is located, and is wound on the annular body 11 described with reference to FIG. 1A in regions RA₁ to RA₈. The winding portion 21a′ is wound in order from the region RA₁ to the region RA₈. The winding portion 21a′ makes three and five-eighths loops in the circumferential direction of the annular body 11 and terminates at the other end which is located in the region RA₆ and faces the shaft hole 14 of the annular body 11 and at which the extraction portion 26c′ is located. The winding portion 21a′ is wound eight turns on the annular body 11 every time the winding portion 21a′ makes one loop in the circumferential direction of the annular body 11.

The winding portion 21b′ has one end which faces the shaft hole 14 of the annular body 11 described with reference to FIG. 1A and at which the extraction portion 26c′ is located, and is wound on the annular body 11 in regions RB₁ to RB₈. The winding portion 21b′ is wound first in order from the region RB₆ to the region RB₈ and then in order from the region RB₁ to the region RB₅. The winding portion 21b′ makes three and five-eighths loops in the circumferential direction of the annular body 11 and terminates at the other end which is located in the region RB₃ and faces the shaft hole 14 of the annular body 11 and at which the extraction portion 26b′ is located. The winding portion 21b′ is wound eight turns on the annular body 11 every time the winding portion 21b′ makes one loop in the circumferential direction of the annular body 11.

The winding portion 21c′ has one end which faces the shaft hole 14 of the annular body 11 described with reference to FIG. 1A and at which the extraction portion 26b′ is located, and is wound on the annular body 11 in regions RC₁ to RC₈. The winding portion 21c′ is wound first in order from the region RC₃ to the region RC₈ and then in order from the region RC₁ to the region RC₂. The winding portion 21c′ makes three and five-eighths loops in the circumferential direction of the annular body 11 and terminates at the other end located in the region RC₈ and facing the shaft hole 14 of the annular body 11. The winding portion 21c′ is wound eight turns on the annular body 11 every time the winding portion 21c′ makes one loop in the circumferential direction of the annular body 11.

As described above, the winding portions 21a′ to 21c′, which extend from the first end 22a to the second end 22b, make a total of 10 and 7/8 loops around the annular body 11 described with reference to FIG. 1A without being turned back in the circumferential direction of the annular body 11 and are wound 87 turns on the annular body 11. That is, the conductive wire 20′ is configured as a coil with 87 turns. Each of the winding portions 21a′ to 21c′ is wound on the annular body 11 at slightly different locations in the circumferential direction of the annular body 11 for different loops that the winding portion 21a′, 21b′, or 21c′ makes in the circumferential direction of the annular body 11. Thus, each of the winding portions 21a′ to 21c′ is wound on the annular body 11 in such a manner that different portions of the winding portion 21a′, 21b′, or 21c′ itself are not in contact with each other.

The electric motor 10B is configured as a three-phase AC motor. For example, a U-phase of an AC voltage is applied to the extraction portion 26a′, a V-phase of the AC voltage is applied to the extraction portion 26b′, and a W-phase of the AC voltage is applied to the extraction portion 26c′. Also in this configuration, the conductive wire 20′ makes an electromagnetic interaction with the permanent magnets 30′ and 40′ to generate an electromagnetic force acting in the circumferential direction of the annular body 11 described with reference to FIG. 1A, and thus the conductive wire 20′ can continue to rotate in the circumferential direction of the annular body 11.

### Advantages of Second Embodiment

The electric motor 10B according to the present embodiment can operate with high energy efficiency for the same reason as the electric motor 10A according to the first embodiment described above. Additionally, the electric motor 10B can offer the various advantages mentioned in relation to the basic concept described with reference to FIGS. 1A to 1H for the electric motor according to the present invention.

### Modifications to Second Embodiment

In the present embodiment, an example has been described in which the permanent magnets 30′ and 40′ as shown in FIG. 4 are used as the other of the first and second elements. This example is not limiting, and conductors having the same shape and size as the permanent magnets 30′ and 40′ may be used in place of the permanent magnets 30′ and 40′. With such a configuration, the electric motor 10B can be operated on the same principle as an induction motor. When conductors are used in place of the permanent magnets 30′ and 40′, the conductors are not limited to having the same shape and size as the permanent magnets 30′ and 40′ and may have different shapes and sizes.

The electric motor 10B may be configured as a DC motor that is divisible. For example, when one and the same conductive wire 20′ configured as a coil with 12 turns is used, the locations or number of portions at which a voltage is applied may be changed to divide the motor into 12 sets of magnetic poles arranged as SNSNSNSNSNSNSNSNSNSNSNSN, six sets of magnetic poles arranged as SSNNSSNNSSNNSSNNSSNNSSNN, four sets of magnetic poles arranged as SSSNNNSSSNNNSSSNNNSSSNNN, three sets of magnetic poles arranged as SSSSNNNNSSSSNNNNSSSSNNNN, or two sets of magnetic poles arranged as SSSSSSNNNNNNSSSSSSNNNNNN. The permanent magnets 30′ and 40′ may be disposed to fit the way in which the motor is divided into a plurality of sets of magnetic poles.

### Third Embodiment

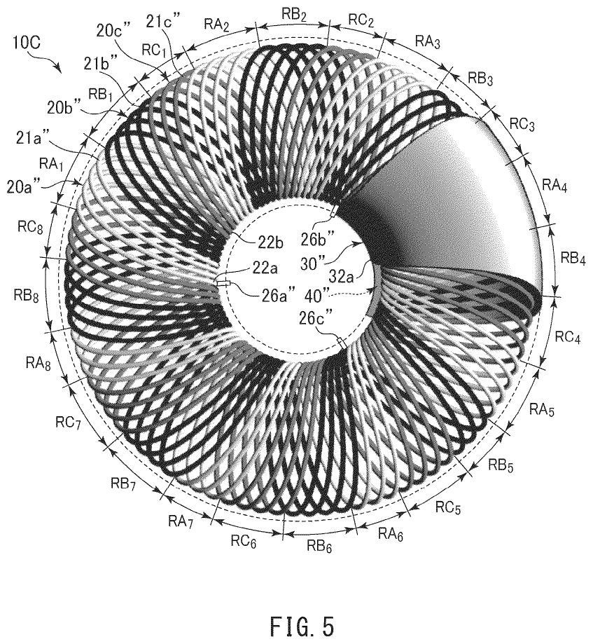

FIG. 5 is a schematic view showing an electric motor according to a third embodiment of the present invention. The electric motor 10C according to the present embodiment has the same configuration as the electric motor 10B described above, except that conductive wires 20″ are different in configuration from the conductive wire 20′. The components of the electric motor 10C that are identical to components of the electric motor 10B are denoted by the same reference signs as the components of the electric motor 10B, and descriptions as given above for such components will not be repeated.

The electric motor 10C according to the present embodiment includes three conductive wires 20a″ to 20c″ (a plurality of conductive wires) and permanent magnets 30″ and 40″. The conductive wire 20a″ includes a winding portion 21a″ (AC winding portion) making three and five-eighths loops around the annular body 11 described with reference to FIG. 1A in the circumferential direction of the annular body 11. The conductive wire 20b″ includes a winding portion 21b″ (AC winding portion) making three and five-eighths loops around the annular body 11 in the circumferential direction of the annular body 11. The conductive wire 20c″ includes a winding portion 21c″ (AC winding portion) making three and five-eighths loops around the annular body 11 in the circumferential direction of the annular body 11.

The winding portion 21a″ has the first end 22a at which an extraction portion 26a″ (AC voltage application portion) is located, and is wound on the annular body 11 described with reference to FIG. 1A in regions RA₁ to RA₈. The winding portion 21a″ is wound in order from the region RA₁ to the region RA₈. The winding portion 21a″ makes three and five-eighths loops in the circumferential direction of the annular body 11 and terminates at the other end which is located in the region RA₆ and faces the shaft hole 14 of the annular body 11 and at which an extraction portion 26c″ is located. The winding portion 21a″ is wound eight turns on the annular body 11 every time the winding portion 21a″ makes one loop in the circumferential direction of the annular body 11.

The winding portion 21b″ has one end which faces the shaft hole 14 of the annular body 11 described with reference to FIG. 1A and at which the extraction portion 26c″ (AC voltage application portion) is located, and is wound on the annular body 11 in regions RB₁ to RB₈. The winding portion 21b″ is wound first in order from the region RB₆ to the region RB₈ and then in order from the region RB₁ to the region RB₅. The winding portion 21b″ makes three and five-eighths loops in the circumferential direction of the annular body 11 and terminates at the other end which is located in the region RB₃ and faces the shaft hole 14 of the annular body 11 and at which an extraction portion 26b″ is located. The winding portion 21b″ is wound eight turns on the annular body 11 every time the winding portion 21b″ makes one loop in the circumferential direction of the annular body 11.

The winding portion 21c″ has one end which faces the shaft hole 14 of the annular body 11 described with reference to FIG. 1A and at which the extraction portion 26b″ (AC voltage application portion) is located, and is wound on the annular body 11 in regions RC₁ to RC₈. The winding portion 21c″ is wound first in order from the region RC₃ to the region RC₈ and then in order from the region RC₁ to the region RC₂. The winding portion 21c″ makes three and five-eighths loops in the circumferential direction of the annular body 11 and terminates at the other end located in the region RC₈ and facing the shaft hole 14 of the annular body 11. The winding portion 21c″ is wound eight turns on the annular body 11 every time the winding portion 21c″ makes one loop in the circumferential direction of the annular body 11.

The electric motor 10C is configured as a three-phase AC motor. For example, as in the electric motor 10B described above, different phases of a three-phase AC voltage are applied to the extraction portions 26a″ to 26c″, respectively, and the three conductive wires 20a″ to 20c″ make an electromagnetic interaction with the permanent magnets 30″ and 40″ to generate an electromagnetic force acting in the circumferential direction of the annular body 11. The electromagnetic force allows the conductive wires 20a″ to 20c″ to continue to rotate in the circumferential direction of the annular body 11.

### Advantages of Third Embodiment

The electric motor 10C according to the present embodiment can operate with high energy efficiency for the same reason as the electric motor 10A or 10B according to the first embodiment described above. Additionally, despite the three-phase configuration, connections can be established by one conductive wire without forming any joint, turning back the conductive wire, or causing different portions of the conductive wire to intersect each other. Thus, each of the conductive wires 20a″ to 20c″ may be in the form of a hollow conductor, through which a refrigerant can be made to flow efficiently. Furthermore, the electric motor 10C can offer the various advantages mentioned in relation to the basic concept described with reference to FIGS. 1A to 1H for the electric motor according to the present invention.

### Modifications to Third Embodiment

In the present embodiment, an example has been described in which the permanent magnets 30″ and 40″ as shown in FIG. 5 are used as the other of the first and second elements. This example is not limiting, and conductors having the same shape and size as the permanent magnets 30″ and 40″ may be used in place of the permanent magnets 30″ and 40″. With such a configuration, the electric motor 10C can be operated on the same principle as an induction motor. When conductors are used in place of the permanent magnets 30″ and 40″, the conductors are not limited to having the same shape and size as the permanent magnets 30″ and 40″ and may have different shapes and sizes.

The electric motor 10C may be configured as an AC motor that is divisible. For example, when the same conductive wires 20″ each of which is configured as a coil with 12 turns are used, the locations or number of portions at which a voltage is applied may be changed to divide the motor into 12 sets of magnetic poles arranged as SNSNSNSNSNSNSNSNSNSNSNSN, six sets of magnetic poles arranged as SSNNSSNNSSNNSSNNSSNNSSNN, four sets of magnetic poles arranged as SSSNNNSSSNNNSSSNNNSSSNNN, three sets of magnetic poles arranged as SSSSNNNNSSSSNNNNSSSSNNNN, or two sets of magnetic poles arranged as SSSSSSNNNNNNSSSSSSNNNNNN. The permanent magnets 30″ and 40″ may be disposed to fit the way in which the motor is divided into a plurality of sets of magnetic poles.

### Fourth Embodiment

FIGS. 6A and 6B are schematic views showing an electric motor according to a fourth embodiment of the present invention. FIG. 6A is a plan view and FIG. 6B is a side view.

As shown in FIGS. 6A and 6B, the electric motor 10D according to the present embodiment includes: three conductive wires 70a to 70c (first element) each of which forms a helix angle with a line extending in the circumferential direction of a flat annular body (not shown) having a smaller thickness than the annular body 11 described with reference to FIGS. 1A and 1s wound on the annular body without being turned back in the circumferential direction of the annular body; and permanent magnets 80a to 80f, 85a to 85f, 90a to 90f, and 95a to 95f (second element) located in association with the conductive wires 20a to 70c to make an electromagnetic interaction with the conductive wires 70a to 70c to generate an electromagnetic force acting in the circumferential direction of the annular body. Electromagnets may be disposed in place of the permanent magnets 80a to 80f, 85a to 85f, 90a to 90f, and 95a to 95f.

In the present embodiment, the conductive wire 70a includes a winding portion 71a (AC winding portion) making one loop around the flat annular body in the circumferential direction of the annular body, the conductive wire 70b includes a winding portion 71b (AC winding portion) making one loop around the annular body in the circumferential direction of the annular body, and the conductive wire 70c includes a winding portion 71c (AC winding portion) making one loop around the annular body in the circumferential direction of the annular body.

The winding portion 71a has one end at which an extraction portion 76a (voltage application portion) is located, and makes one loop in the circumferential direction of the flat annular body while being wound six turns around the line extending in the circumferential direction of the annular body. The winding portion 71b has one end at which an extraction portion 76b (voltage application portion) is located, and makes one loop in the circumferential direction of the annular body while being wound six turns around the line extending in the circumferential direction of the annular body. The winding portion 71c has one end at which an extraction portion 76c (voltage application portion) is located, and makes one loop in the circumferential direction of the annular body while being wound six turns around the line extending in the circumferential direction of the annular body. The winding portions 71a to 71c are at slightly different locations in the circumferential direction of the annular body to avoid contact with each other.

The permanent magnets 80a to 80f or 85a to 85f are arranged on one side in the thickness direction of the flat annular body, i.e., the thickness direction of the electric motor 10D (the side seen in FIG. 6A or the upper side in FIG. 6B) along the circumference of a circle centered on the central axis of the annular body. The permanent magnet 85a is located between the permanent magnets 80a and 80b, the permanent magnet 85b is located between the permanent magnets 80b and 80c, the permanent magnet 85c is located between the permanent magnets 80c and 80d, the permanent magnet 85d is located between the permanent magnets 80d and 80e, the permanent magnet 85e is located between the permanent magnets 80e and 80f, and the permanent magnet 85f is located between the permanent magnets 80f and 80a.

The permanent magnets 80a to 80f or 85a to 85f are plate-shaped magnets having the same shape and size. The permanent magnets 80a to 80f or 85a to 85f are not limited to being plate-shaped magnets having the same shape and size and may have different shapes and sizes. Each of the permanent magnets 80a to 80f or 85a to 85f has a width that increases outward in the radial direction of the flat annular body. The permanent magnets 80a to 80f or 85a to 85f are arranged along the circumference of a circle centered on the central axis of the annular body, regardless of locations in the radial direction of the annular body. Each of the permanent magnets 80a to 80f has a north pole on its upper surface and a south pole on its lower surface. Each of the permanent magnets 85a to 85f has a south pole on its upper surface and a north pole on its lower surface.

The permanent magnets 90a to 90f or 95a to 95f are arranged on the other side in the thickness direction of the flat annular body (the side hidden in FIG. 6A, the lower side in FIG. 6B) along the circumference of a circle centered on the central axis of the annular body. The permanent magnets 90a to 90f or 95a to 95f are plate-shaped magnets having the same shape and size as the permanent magnets 80a to 80f or 85a to 85f descried above and are arranged along the circumference of a circle centered on the central axis of the annular body. The permanent magnets 90a to 90f or 95a to 95f are not limited to being plate-shaped magnets having the same shape and size as the permanent magnets 80a to 80f or 85a to 85f and may have different shapes and sizes.

The electric motor 10D is configured as a three-phase AC motor. For example, as in the electric motors 10B and 10C described above, a three-phase AC voltage is applied to the extraction portions 76a to 76c, and thus the three conductive wires 70a to 70c make an electromagnetic interaction with the permanent magnets 80a to 80f, 85a to 85f, and 95a to 95f to generate an electromagnetic force acting in the circumferential direction of the flat annular body. The electromagnetic force allows the conductive wires 70a to 70c to continue to rotate in the circumferential direction of the annular body.

### Advantages of Fourth Embodiment

The electric motor 10D according to the present embodiment can operate with high energy efficiency or the same reason as the electric motors 10A to 10C according to the first embodiment described above. Additionally, the electric motor 10D can offer the various advantages mentioned in relation to the basic concept described with reference to FIGS. 1A to 1H for the electric motor according to the present invention.

### Modifications to Fourth Embodiment

In the present embodiment, an example has been described in which the permanent magnets 80a to 80f, 85a to 85f, 90a to 90f, and 95a to 95f as shown in FIG. 6 are used as the second element. This example is not limiting, and conductors having the same shape and size as the permanent magnets 80a to 80f, 85a to 85f, 90a to 90f, and 95a to 95f may be used in place of the permanent magnets 80a to 80f, 85a to 85f, 90a to 90f, and 95a to 95f. With such a configuration, the electric motor 10D can be operated on the same principle as an induction motor. When conductors are used in place of the permanent magnets 80a to 80f, 85a to 85f, 90a to 90f, and 95a to 95f, the conductors are not limited to having the same shape and size as the permanent magnets 80a to 80f, 85a to 85f, 90a to 90f, and 95a to 95f and may have different shapes and sizes.

### Fifth Embodiment

FIG. 7 is an external perspective view showing an electric motor according to a fifth embodiment of the present invention. In FIG. 7, a ring-shaped body 150 is depicted as transparent by dashed lines to show the internal configuration of the electric motor 10E. As shown in FIG. 7, the electric motor 10E according to the present embodiment includes: a ferromagnet 102 (first element) forming a helix angle with a line extending in the circumferential direction of the annular body 11 described with reference to FIG. 1A and wound on the annular body 11 without being turned back in the circumferential direction; and nine permanent magnets 130a to 130i fixed to the ferromagnet 102. The electric motor 10E further includes: an annular conductive wire 140 which extends in the circumferential direction of the annular body 11 and on which the ferromagnet 102 is wound; and the ring-shaped body 150 (second element) coaxially surrounding the annular body 11 when viewed in the axial direction of the annular body 11.

The ferromagnet 102 includes nine ferromagnet segments 110a to 110i having the same shape and size. FIG. 8 is an external perspective view of the ferromagnet segment 110a and the permanent magnet 130a fixed to the ferromagnet segment 110a. As shown in FIG. 8, the ferromagnet segment 110a includes a first portion 111 contacting the permanent magnet 130a and magnetized as a north pole by the permanent magnet 130a. The ferromagnet segment 110a further includes a second portion 112 extending from the first portion 111 in one direction, forming a helix angle with the line extending in the circumferential direction of the annular body 11 described with reference to FIG. 1A, and wound on a part of the annular body 11 and a part of the conductive wire 140. The ferromagnet segment 110a further includes a third portion 113 extending from the first portion 111 in another direction opposite to the one direction in which the second portion 112 extends, forming a helix angle with the line extending in the circumferential direction of the annular body 11, and wound on another part of the annular body 11 and another part of the conductive wire 140.

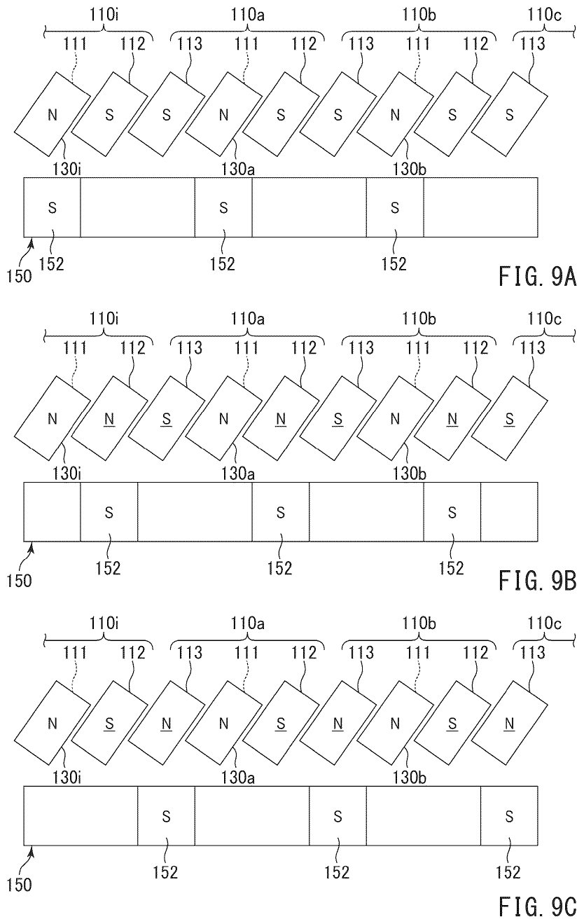

FIGS. 9A to 9C are schematic views for describing an electromagnetic interaction which occurs in the electric motor according to the present embodiment. FIG. 9A shows a state where no AC voltage has been applied to the conductive wire, FIG. 9B shows a first magnetized state resulting from AC voltage application to the conductive wire, and FIG. 9C shows a second magnetized state resulting from AC voltage application to the conductive wire.

As shown in FIGS. 9A to 9C, the ring-shaped body 150 includes a plurality of fourth portions 152 facing the annular body 11 described with reference to FIG. 1A. Each of the fourth portions 152 is magnetized as a south pole. The fourth portions 152 are arranged at regular intervals in the circumferential direction of the annular body 11. Each of the intervals between the fourth portions 152 corresponds to the length of the permanent magnet 130a (or a corresponding one of the permanent magnets 130b to 130i) in the circumferential direction of the annular body 11.

As shown in FIG. 9A, in the state where no AC voltage has been applied to the conductive wire 140 (or the state where an AC voltage has been applied but the AC voltage is 0 V), the first portion 111 of the ferromagnet segment 110a is magnetized as a north pole by the permanent magnet 130a, and accordingly the end surface of each of the second and third portions 112 and 113 of the ferromagnet segment 110a is magnetized as a south pole. The same phenomenon applies to the ferromagnet segments 110b to 110i.

As shown in FIG. 9B, once an AC voltage is applied to the conductive wire 140, the ferromagnet segment 110a is brought into the first magnetized state where the end surface of the second portion 112 (the end of the second portion opposite from the first portion) is more strongly magnetized as a north pole than the first portion 111 and where the end surface of the third portion 113 (the end of the third portion opposite from the first portion) is magnetized as a south pole with a magnetization intensity corresponding to that of the north pole of the end surface of the second portion 112. Thus, the end surface of the second portion 112 of the ferromagnet segment 110a is attracted toward the south pole of the fourth portion 152 of the ring-shaped body 150, and the ferromagnet 102 and the conductive wire 140 rotate from the state of FIG. 9A relative to the ring-shaped body 150. The same phenomenon applies to the ferromagnet segments 110b to 110i.

As shown in FIG. 9C, once the phase is reversed from the state of FIG. 9B after AC voltage application to the conductive wire 140, the ferromagnet segment 110a is brought into the second magnetized state where the end surface of the second portion 112 is more strongly magnetized as a south pole than the first portion 111 and where the end surface of the third portion 113 is magnetized as a north pole with a magnetization intensity corresponding to that of the south pole of the end surface of the second portion 112. Thus, the end surface of the third portion 113 of the ferromagnet segment 110a is attracted toward the south pole of the fourth portion 152 of the ring-shaped body 150, and the ferromagnet 102 and the conductive wire 140 rotate from the state of FIG. 9B relative to the ring-shaped body 150. The same phenomenon applies to the ferromagnet segments 110b to 110i.

As described above, AC voltage application to the conductive wire 140 gives rise to transition between the states of FIGS. 9A to 9C. Specifically, the first magnetized state of FIG. 9B and the second magnetized state of FIG. 9C alternate with each other. Repeated alternation of the first and second magnetized states allows the ferromagnet 102 and the conductive wire 140 to continue to rotate over the entire circumference of the annular body 11 described with reference to FIG. 1A. The AC voltage as mentioned herein may assume a no-voltage state before transition from negative to positive. For example, the AC voltage may change from positive to negative and to 0 (no-voltage state) and then to positive, to negative, and to 0 (no-voltage state).

### Advantages of Fifth Embodiment

The electric motor 10E according to the present embodiment can operate with high energy efficiency for the same reason as the electric motor 10A according to the first embodiment described above. In the present embodiment, since the ferromagnet 102, rather than the conductive wire 140, is divided into segments, electrical resistance which would occur due to division of the conductive wire 140 can be suppressed, and this allows for high performance of the electric motor 10E. In the present embodiment, since the ferromagnet 102 covers the periphery of the conductive wire 140, it is possible to prevent a magnetic flux from leaking out and adversely affecting the surroundings of the electric motor 10E. In the present embodiment, the ferromagnet 102 is wound on the surface of the annular body 11 described with reference to FIGS. 1A and 1s relatively slender. Such a ferromagnet 102 is magnetized. Thus, a magnet-related property called L/D ratio is improved, and self-demagnetization can be reduced. This enables the electric motor 10E according to the present embodiment to operate with further enhanced energy efficiency. Additionally, the electric motor 10E can offer the various advantages mentioned in relation to the basic concept described with reference to FIGS. 1A to 1H for the electric motor according to the present invention.

### Modifications to Fifth Embodiment

In the present embodiment, an example has been described in which the first portion 111 of each of the ferromagnet segments 110a to 110i is magnetized as a north pole by a corresponding one of the permanent magnets 130a to 130i. This example is not limiting, and the first portion 111 of each of the ferromagnet segments 110a to 110i may be magnetized as a south pole by a corresponding one of the permanent magnets 130a to 130i. Alternatively, the first portion 111 of each of the ferromagnet segments 110a to 110i may be magnetized as a north pole or south pole by an electromagnet. In such a case, the first portion 111 of each of the ferromagnet segments 110a to 110i may be located in proximity to the electromagnet without contact with the electromagnet.

In the present embodiment, an example has been described in which the fourth portions 152 of the ring-shaped body 150 are magnetized as south poles. This example is not limiting, and the fourth portions 152 of the ring-shaped body 150 may be magnetized as north poles. The intervals between the fourth portions 152 may be appropriately adjusted such that some of the fourth portions 152 are magnetized as north poles while the other fourth portions 152 are magnetized as south poles.

In the present embodiment, an example has been described in which the ferromagnet 102 includes the nine ferromagnet segments 110a to 110i. This example is not limiting, and the ferromagnet 102 may include one to eight ferromagnet segments or 10 or more ferromagnet segments.

In the present embodiment, an example has been described in which upon application of an AC voltage to the conductive wire 140, the ferromagnet segment 110a alternates between the first magnetized state where the end surface of the second portion 112 is relatively strongly magnetized as a north pole and the end surface of the third portion 113 is relatively strongly magnetized as a south pole and the second magnetized state where the end surface of the second portion 112 is relatively strongly magnetized as a south pole and the end surface of the third portion 113 is relatively strongly magnetized as a north pole. This example is not limiting, and a configuration may be employed in which upon application of an AC voltage to the conductive wire 140, the ferromagnet segment 110a alternates between: a first magnetized state where the end of the second portion 112 opposite from the first portion 111 is magnetized as a north pole and the end of the third portion 113 opposite from the first portion 111 is more weakly magnetized as a north pole than the end of the second portion 112 opposite from the first portion 111, or magnetized as a south pole, or not magnetized at all; and a second magnetized state where the end of the second portion 112 opposite from the first portion 111 is magnetized as a south pole and the end of the third portion 113 opposite from the first portion 111 is more weakly magnetized as a south pole than the end of the second portion 112 opposite from the first portion 111, or magnetized as a north pole, or not magnetized at all.

In the present embodiment, an example has been described in which the ferromagnet 102 and the conductive wire 140 constitute a part of a rotor, and the ring-shaped body 150 constitutes a part of a stator. This example is not limiting, and the ferromagnet 102 and the conductive wire 140 may constitute a part of the stator, and the ring-shaped body 150 may constitute a part of the rotor. Alternatively, for example, the conductive wire 140 and the ring-shaped body 150 may constitute at least a part of the stator, and the ferromagnet 102 may constitute at least a part of the rotor.

The cost for the winding does not change even if the number of poles is increased. The greater the number of poles is, the thinner the winding is. Thus, improvements in terms of L/D ratio, permeance coefficient, and resolution can be achieved.

### Sixth Embodiment

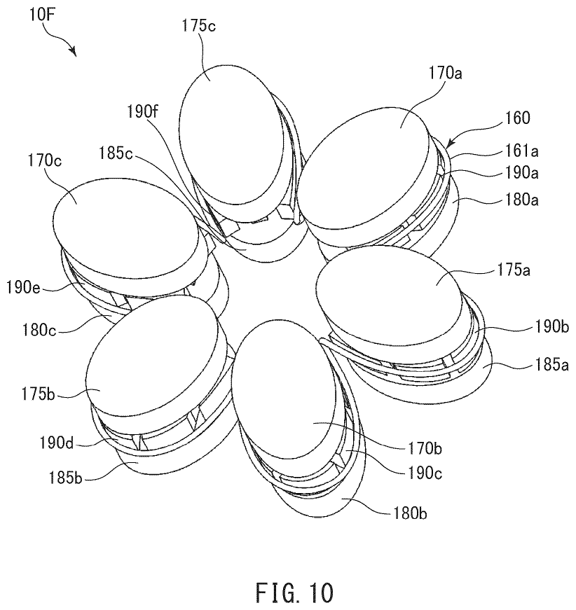

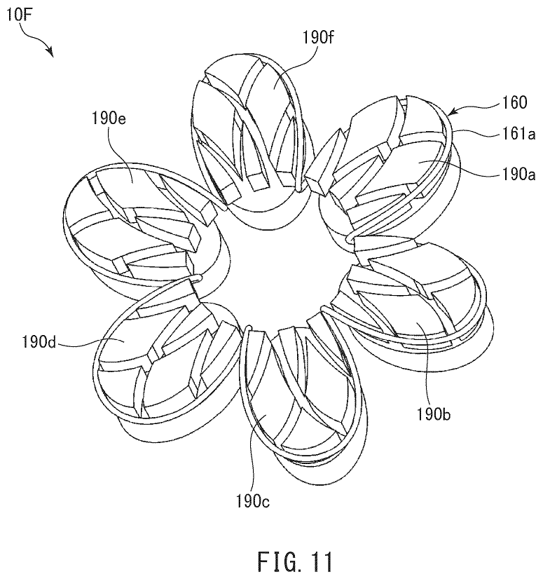

FIG. 10 is an external perspective view showing an electric motor according to a sixth embodiment of the present invention. FIG. 11 is a schematic view in which permanent magnets are omitted to show the internal configuration of the electric motor according to the present embodiment. As shown in FIGS. 10 and 11, the electric motor 10F according to the present embodiment includes: a conductive wire 160 (first element) forming a helix angle with a line extending in the circumferential direction of a flat annular body (not shown) having a smaller thickness than the annular body 11 described with reference to FIG. 1A, the conductive wire 160 being wound on the annular body without being turned back in the circumferential direction of the annular body; permanent magnets 170a to 170c, 175a to 175c, 180a to 180c, and 185a to 185c (second element) located in association with the conductive wire 160 to make an electromagnetic interaction with the conductive wire 160 to generate an electromagnetic force acting in the circumferential direction of the annular body. The electric motor 10F according to the present embodiment further includes six ferromagnets 190a to 190f.

In the present embodiment, the conductive wire 160 includes a winding portion 161a (DC winding portion) making one loop around the flat annular body in the circumferential direction of the annular body. The winding portion 161a makes one loop in the circumferential direction of the annular body while being wound six turns around the line extending in the circumferential direction of the annular body. That is, the winding portion 160a includes six portions each of which is wound one turn around the line. The ferromagnets 190a to 190f are disposed in one-to-one correspondence with the six portions each of which is wound one turn around the line.

The ferromagnets 190a to 190f, as viewed in the thickness direction of the flat annular body, are arranged along the circumference of a circle centered on the central axis of the annular body. The ferromagnet 190a to 190f have the same shape and size.

Each of the ferromagnets 190a to 190f, as viewed in the thickness direction of the flat annular body, includes a first outer edge portion that is in contact with or in proximity to the winding portion 160a of the conductive wire 160 at a location toward the center of the annular body in the radial direction of the annular body. The first outer edge portion, as viewed in the thickness direction of the annular body, is curved to project outward in the radial direction of the annular body. Each of the ferromagnets 190a to 190f, as viewed in the thickness direction of the annular body, includes an arc-shaped second outer edge portion connecting two ends of the first outer edge portion that face the center of the annular body in the radial direction of the annular body. The second outer edge portion is curved to project outward in the radial direction of the annular body.

Each of the ferromagnets 190a to 190f includes six ferromagnet segments arranged adjacent to each other. The outer edges of the six ferromagnet segments, as viewed in the thickness direction of the flat annular body, are combined together to define the first and second outer edge portions.

Each of the ferromagnets 190a to 190f having the first and second outer edge portions is shaped like a flower petal when viewed in the thickness direction of the flat annular body. The ferromagnets 190a to 190f together form a flower-like shape centered on the central axis of the annular body.

As shown in FIG. 10, the permanent magnets 170a to 170c or 175a to 175c are arranged on one side in the thickness direction of the flat annular body (the side seen in FIG. 10) along the circumference of a circle centered on the central axis of the annular body. The permanent magnet 175a is located between the permanent magnets 170a and 170b, the permanent magnet 175b is located between the permanent magnets 170b and 170c, and the permanent magnet 175c is located between the permanent magnets 170c and 170a. The permanent magnets 170a to 170c or 175a to 175c do not have alternating poles but have the same pole arrangement.

The permanent magnets 170a to 170c or 175a to 175c are plate-shaped magnets having the same shape and size. Each of the permanent magnets 170a to 170c or 175a to 175c, as viewed in the thickness direction of the flat annular body, includes: a third outer edge portion overlapping the first outer edge portion of a corresponding one of the ferromagnets 190a to 190f; and a fourth outer edge portion curved to project inward in the radial direction of the annular body from two ends of the third outer edge portion that face the center of the annular body in the radial direction of the annular body. Thus, each of the permanent magnets 170a to 170c or 175a to 175c, as viewed in the thickness direction of the annular body, is generally elliptical. Each of the permanent magnets 170a to 170c has a north pole on its upper surface (the surface seen in FIG. 10) and a south pole on its lower surface (the opposite surface hidden in FIG. 10). Each of the permanent magnets 175a to 175f has a south pole on its upper surface and a north pole on its lower surface.

As shown in FIG. 10, the permanent magnets 180a to 180c or 185a to 185c are arranged on the other side in the thickness direction of the flat annular body (the side hidden in FIG. 10) along the circumference of a circle centered on the central axis of the annular body. The permanent magnets 180a to 180c or 185a to 185c are plate-shaped magnets having the same shape and size as the permanent magnets 180a to 180c or 185a to 185c described above and are arranged along the circumference of a circle centered on the central axis of the annular body in the same manner as the permanent magnets 180a to 180c or 185a to 185c. The permanent magnets 180a to 180c or 185a to 185c do not have alternating poles but have the same pole arrangement.

The electric motor 10F is configured as a DC motor. In the present embodiment, the conductive wire 160 constitutes at least a part of the rotor of the electric motor 10F, and the permanent magnets 170a to 170c, 175a to 175c, 180a to 180c, and 185a to 185c constitute at least a part of the stator of the electric motor 10F. In the electric motor 10F, voltage application to any part of the winding portion 161a of the conductive wire 160 generates an electromagnetic force acting in the circumferential direction of the flat annular body, and the electromagnetic force allows the conductive wire 160 and the ferromagnets 190a to 190f to continue to rotate in the circumferential direction of the annular body. The electromagnetic force is enhanced by the ferromagnets 190a to 190f.

### Advantages of Sixth Embodiment

The electric motor 10F according to the present embodiment can operate with high energy efficiency for the same reason as the electric motor 10A according to the first embodiment described above. Additionally, the electric motor 10F can offer the various advantages mentioned in relation to the basic concept described with reference to FIGS. 1A to 1H for the electric motor according to the present invention.

In the present embodiment, any part of the conductive wire 160 as viewed along the central axis of the flat annular body does not overlap any other part of the conductive wire 160. Thus, the electric motor 10F can be slim as a whole.

### Modifications to Sixth Embodiment

In the present embodiment, an example has been described in which the winding portion 161a of the conductive wire 160 makes one loop in the circumferential direction of the flat annular body while being wound six turns around the line extending in the circumferential direction of the annular body and in which the ferromagnets 190a to 190f are disposed in one-to-one correspondence with the six wound portions each of which is wound one turn around the line. This example is not limiting, and the winding portion 161a of the conductive wire 160 may make one loop in the circumferential direction of the flat annular body while being wound less than six turns or seven or more turns around the line extending in the circumferential direction of the annular body, and ferromagnets may be disposed in one-to-one correspondence with the less than six, or seven or more, wound portions each of which is wound one turn around the line.

In the present embodiment, an example has been described in which the conductive wire 160 constitutes at least a part of the rotor of the electric motor 10F, and the permanent magnets 170a to 170c, 175a to 175c, 180a to 180c, and 185a to 185c constitute at least a part of the stator of the electric motor 10F. This example is not limiting, and the conductive wire 160 may constitute at least a part of the stator, and the permanent magnets 170a to 170c, 175a to 175c, 180a to 180c, and 185a to 185c may constitute at least a part of the rotor.

### Seventh Embodiment

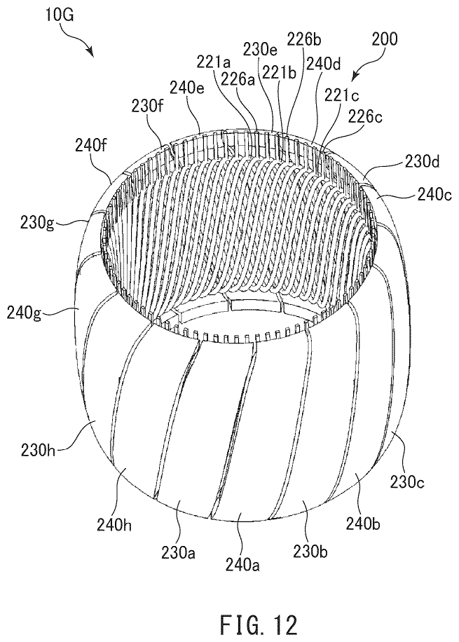

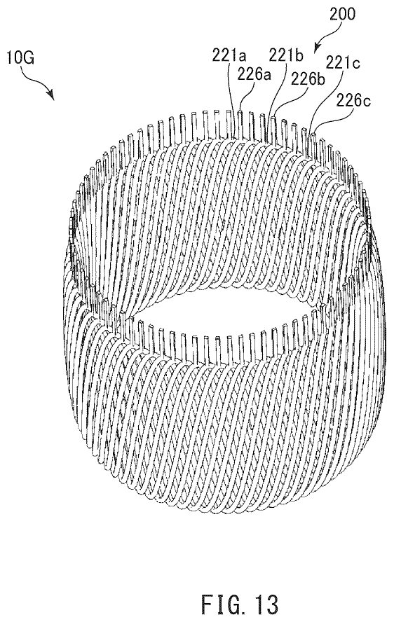

FIG. 12 is an external perspective view showing an electric motor according to a seventh embodiment of the present invention. FIG. 13 is a schematic view in which permanent magnets are omitted to show the internal configuration of the electric motor according to the present embodiment. As shown in FIGS. 12 and 13, the electric motor 10G according to the present embodiment includes a single conductive wire 200 (first element) forming a helix angle with a line extending in the circumferential direction of a cylindrical annular body (not shown) longer than the annular body 11 described with reference to FIG. 1A in the direction of the central axis, the conductive wire 200 being wound on the annular body without being turned back in the circumferential direction of the annular body. The electric motor 10G includes permanent magnets 230a to 230h and 240a to 240h (second element) located in association with the conductive wire 200 to make an electromagnetic interaction with the conductive wire 200 to generate an electromagnetic force acting in the circumferential direction of the annular body.

The conductive wire 200 includes: winding portions 221a to 221c (AC winding portions) each of which makes three and three-eighths loops around the cylindrical annular body in the circumferential direction of the annular body; and extraction portions 226a to 226c (AC voltage application portions) located on the winding portions 221a to 221c to apply an AC voltage to the electric motor 10G.

The winding portions 221a to 221c of the conductive wire 200 are wound on the cylindrical annular body in the same manner as the winding portions 21a′ to 21c′ of the conductive wire 20′ described with reference to FIG. 4 are wound on the annular body 11 described with reference to FIG. 1A, and the manner in which the winding portions are wound will not be described again.

The extraction portions 226a to 226c of the conductive wire 200 are located at all the ends of the winding portions 221a to 221c (the ends seen in FIGS. 12 and 13) at which the winding portions 221a to 221c are turned back in the direction of the central axis of the cylindrical annular body, and project from those ends of the winding portions 221a to 221c along the central axis of the annular body. In FIGS. 12 and 13, one of the extraction portions 226a, one of the extraction portions 226b, and one of the extraction portions 226c are only denoted by the reference signs for the sake of visibility.

The permanent magnets 230a to 230h or 240a to 240h are located outside and adjacent to the winding portions 221a to 221c in the radial direction of the cylindrical annular body. The permanent magnets 230a to 230h or 240a to 240h are wound on the annular body along the winding portions 221a to 221c. As mentioned above, the permanent magnets 230a to 230h or 240a to 240h are located only outside the winding portions 221a to 221c in the radial direction of the annular body. Other permanent magnets paired with the permanent magnets 230a to 230h or 240a to 240h may be located inside the winding portions 221a to 221c in the radial direction of the annular body.

The permanent magnets 230a to 230h or 240a to 240h have the same shape and size. Each of the permanent magnets 230a to 230h has a north pole on its outer surface in the radial direction of the cylindrical annular body and a south pole on its inner surface in the radial direction of the cylindrical annular body. Each of the permanent magnets 240a to 240h has a south pole on its outer surface in the radial direction of the cylindrical annular body and a north pole on its inner surface in the radial direction of the cylindrical annular body. Each of the permanent magnets 230a to 230h or 240a to 240h has a thickness in the radial direction of the annular body and extends generally along the central axis of the annular body.

The permanent magnets 230a to 230h and the permanent magnets 240a to 240h alternate in the circumferential direction of the cylindrical annular body. Specifically, in the circumferential direction of the annular body, the permanent magnet 240a is located between the permanent magnets 230a and 230b, the permanent magnet 240b is located between the permanent magnets 230b and 230c, the permanent magnet 240c is located between the permanent magnets 230c and 230d, the permanent magnet 240d is located between the permanent magnets 230d and 230e, the permanent magnet 240e is located between the permanent magnets 230e and 230f, the permanent magnet 240f is located between the permanent magnets 230f and 230g, the permanent magnet 240g is located between the permanent magnets 230g and 230h, and the permanent magnet 240h is located between the permanent magnets 230h and 230a.

In the present embodiment, the conductive wire 200 constitutes at least a part of the rotor of the electric motor 10G, and the permanent magnets 230a to 230h and 240a to 240h constitute at least a part of the stator of the electric motor 10G. The electric motor 10G is configured as a three-phase AC motor. For example, a U-phase of an AC voltage is applied to any of the extraction portions 226a, a V-phase of the AC voltage is applied to any of the extraction portions 226b, and a W-phase of the AC voltage is applied to any of the extraction portions 226c. As in the electric motor 10B described above, the conductive wire 200 makes an electromagnetic interaction with the permanent magnets 230a to 230h and 240a to 240h to generate an electromagnetic force acting in the circumferential direction of the cylindrical annular body, and the electromagnetic force allows the conductive wire 200 to continue to rotate in the circumferential direction of the annular body.

### Advantages of Seventh Embodiment

The electric motor 10G according to the present embodiment can operate with high energy efficiency for the same reason as the electric motor 10A according to the first embodiment described above. Additionally, the electric motor 10G can offer the various advantages mentioned in relation to the basic concept described with reference to FIGS. 1A to 1H for the electric motor according to the present invention.

### Modifications to Seventh Embodiment

In the present embodiment, an example has been described in which each of the winding portions 221a to 221c of the conductive wire 200 makes three and three-eighths loops around the cylindrical annular body in the circumferential direction of the annular body. This example is not limiting, and each of the winding portions 221a to 221c may make less than three and three-eighths loops or three and half or more loops around the cylindrical annular body in the circumferential direction of the annular body.

In the present embodiment, an example has been described in which the electric motor 10G includes only one conductive wire 200 just as the electric motor 10B described above includes only one conductive wire 20′. This example is not limiting, and the electric motor 10G may include a total of three conductive wires in one-to-one correspondence with the U-, V-, and W-phases of the three-phase AC voltage just as the electric motor 10C described above includes the three conductive wires 20a″ to 20c′.

In the present embodiment, an example has been described in which eight permanent magnets 230a to 230h and eight permanent magnets 240a to 240h are used. This example is not limiting, and, for example, the width (the dimension in the circumferential direction of the cylindrical annular body) of the permanent magnets 230a to 230h or 240a to 240h may be adjusted to arrange a number of permanent magnets 230a to 230h in combination with a different number of permanent magnets 240a to 240h.

In the present embodiment, an example has been described in which the permanent magnets 230a to 230h or 240a to 240h are not located inside the winding portions 221a to 221c but only outside the winding portions 221a to 221c in the radial direction of the cylindrical annular body. This example is not limiting, and the permanent magnets 230a to 230h or 240a to 240h may be located only inside, rather than outside, the winding portions 221a to 221c in the radial direction of the annular body. Alternatively, the permanent magnets 230a to 230h or 240a to 240h may be located both outside and inside the winding portions 221a to 221c in the radial direction of the annular body.

In the present embodiment, an example has been described in which the conductive wire 200 constitutes at least a part of the rotor of the electric motor 10G, and the permanent magnet 230a to 230h and 240a to 240h constitute at least a part of the stator of the electric motor 10G. This example is not limiting, and the conductive wire 200 may constitute at least a part of the stator of the electric motor 10G, and the permanent magnet 230a to 230h and 240a to 240h may constitute at least a part of the rotor of the electric motor 10G.

In the present embodiment, an example has been described in which the permanent magnets 230a to 230h and 240a to 240h as shown in FIG. 12 are used as the second element. This example is not limiting, and conductors having the same shape and size as the permanent magnets 230a to 230h and 240a to 240h may be used in place of the permanent magnets 230a to 230h and 240a to 240h. With such a configuration, the electric motor 10G can be operated on the same principle as an induction motor. When conductors are used in place of the permanent magnets 230a to 230h and 240a to 240h, the conductors are not limited to having the same shape and size as the permanent magnets 230a to 230h and 240a to 240h and may have different shapes and sizes.

### Eighth Embodiment

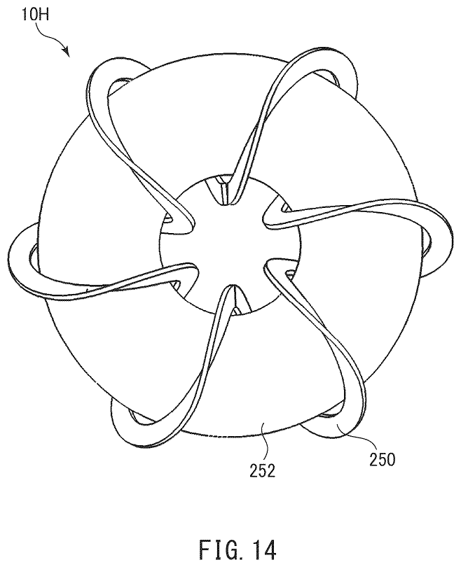

FIG. 14 is an external perspective view which shows an electric motor according to an eighth embodiment of the present invention and in which permanent magnets are omitted. As shown in FIG. 14, the electric motor 10H according to the present embodiment includes: an edgewise coil 250 (first element) forming a helix angle with a line extending in the circumferential direction of the annular body 11 described with reference to FIG. 1A, the edgewise coil 250 being wound on the annular body 11 without being turned back in the circumferential direction; and permanent magnets (second element, which is not shown) located in association with the edgewise coil 250 to make an electromagnetic interaction with the edgewise coil 250 to generate an electromagnetic force acting in the circumferential direction of the annular body 11. The permanent magnets may be arranged, for example, in the same manner as the permanent magnets 30 and 40 described with reference to FIGS. 2 and 3. The edgewise coil 250 is a coil formed by winding a rectangular wire in the width direction of the wire.

### Advantages of Eighth Embodiment

In the electric motor 10H according to the present embodiment, where the first element is configured as the edgewise coil 252, electrostatic field-induced decrease in electrical conductivity can be reduced. Additionally, as shown in FIG. 14, the edgewise coil 252 is wound in a single layer without overlapping of its different portions and thus can achieve a high occupancy density. This can reduce the influence of the proximity effect. Furthermore, winding the coil 252 thinly in an edgewise fashion can reduce the skin effect, and this enables the electric motor 10H to operate with high energy efficiency. Additionally, the electric motor 10H can offer the various advantages mentioned in relation to the basic concept described with reference to FIGS. 1A to 1H for the electric motor according to the present invention.

### Ninth Embodiment

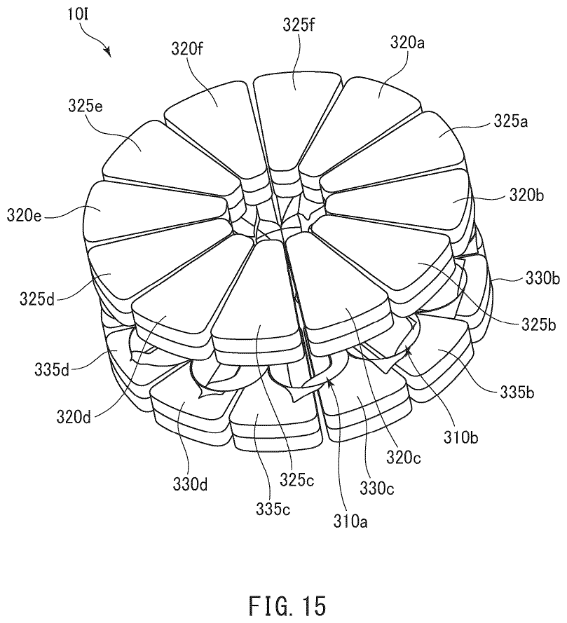

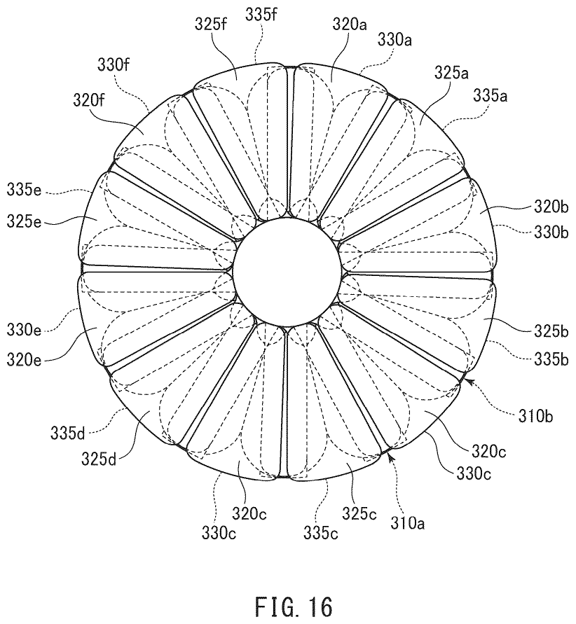

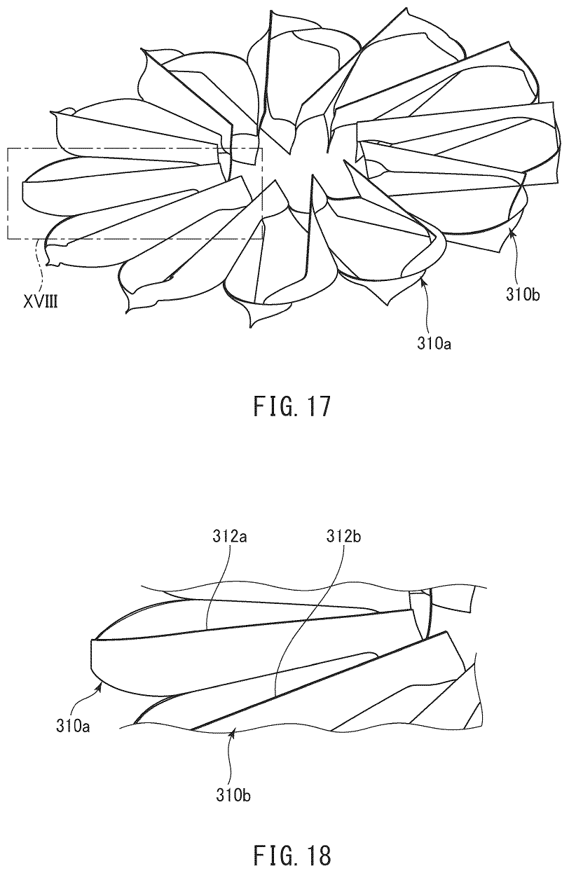

FIG. 15 is an external perspective view showing an electric motor according to a ninth embodiment of the present invention. FIG. 16 is a plan view showing the electric motor according to the ninth embodiment of the present invention. In FIG. 16, coils 310a and 310b hidden under permanent magnets 320a to 320f and 325a to 325f are indicated by dashed lines. FIG. 17 is an external perspective view of the coils 310a and 310b of the electric motor according to the ninth embodiment of the present invention. FIG. 18 is an enlarged view of a region XVIII indicated in FIG. 17.

As shown in FIGS. 15 to 18, the electric motor 10I according to the present embodiment includes: coils 310a and 310b (first element) each of which forms a helix angle with a line extending in the circumferential direction of the annular body 11 described with reference to FIGS. 1A and 1s wound on the annular body 11 without being turned back in the circumferential direction; and permanent magnets 320a to 320f, 325a to 325f, 330a to 330f, and 335a to 335f (second element) located in association with the coils 310a and 310b to make an electromagnetic interaction with the coils 310a and 310b to generate an electromagnetic force acting in the circumferential direction of the annular body 11.

As shown in FIGS. 15 and 16, the permanent magnets 320a to 320f, 325a to 325f, 330a to 330f, or 335a to 335f have the same shape and are arranged in the same manner as the permanent magnets 80a to 80f, 85a to 85f, 90a to 90f, or 95a to 95f described with reference to FIG. 6. The description as given for the permanent magnets 80a to 80f, 85a to 85f, 90a to 90f, or 95a to 95f applies to the permanent magnets 320a to 320f, 325a to 325f, 330a to 330f, or 335a to 335f and will not be repeated.

The coils 310a and 310b are located between the permanent magnets 320a to 320f and 325a to 325f and the permanent magnets 330a to 330f and 335a to 335f in the thickness direction of the electric motor 10I. Currents flow through the coils 310a and 310b in the circumferential direction of the annular body 11 described with reference to FIG. 1A, and the direction of the current in the coil 310a and the direction of the current in the coil 310b are opposite to each other.

The coils 310a and 310b, as viewed in the thickness direction of the electric motor 10I, alternate with each other in the circumferential direction of the electric motor 10I. The coils 310a and 310b have the same shape. Thus, hereinafter, only the coil 310a will be described unless necessary, and the description as given for the coil 310a will not be repeated for the coil 310b.

As shown in FIG. 18, the coil 310a includes first facing portions 312a facing the permanent magnets 320a to 320f and 325a to 325f, and the permanent magnets 320a to 320f and 325a to 325f include second facing portions facing the coil 310a, and the first and second facing portions, as viewed in the thickness direction of the annular body 11 described with reference to FIG. 1A (i.e., the thickness direction of the electric motor 10I), have straight shapes conforming to each other. Likewise, first facing portions of the coil 310a that face the permanent magnets 330a to 330f and 335a to 335f and second facing portions of the permanent magnets 330a to 330f and 335a to 335f that face the coil 310a have straight shapes conforming to each other.

As shown in FIG. 18, portions of the coil 310a that face the coil 310b and portions of the coil 310b that face the coil 310a, as viewed in the thickness direction of the annular body 11 described with reference to FIG. 1A, have straight shapes conforming to each other. As shown in FIG. 18, those straight shapes are shorter than the straight shape of the first facing portions described above.

Each of the coils 310a and 310b may be wound with a curvature corresponding to that of an involute. By this way of winding, each of the coils 310a and 310b can be wound densely at regular intervals. This can eliminate gaps between the coils 310a and 31b to increase the winding density and the percentage of coil-occupied area. The non-straight portions of the coils 310a and 310b may be wound in the shape of an involute to lengthen the straight portions (the first facing portions described above) orthogonal to the rotational direction of the coils 310a and 310b. This makes it possible to adjust and optimize pitches in the diametrical direction of the annular body 11.

### Advantages of Ninth Embodiment

The electric motor 10I according to the present embodiment can operate with high energy efficiency for the same reason as the electric motor 10A according to the first embodiment described above. In the present embodiment, the first facing portions of the coils 310a and 310b are simple in shape and sufficiently long, and the second facing portions of the permanent magnets 320a to 320f, 325a to 325f, 330a to 330f, and 335a to 335f are also simple in shape and sufficiently long. This allows for easy production of the electric motor 10I and enables the electric motor 10I to strikingly exhibit the advantage of being able to operate with high energy efficiency. The coils are wound on the annular body 11 described with reference to FIG. 1A in torus knot forms (bifilar winding) such that the currents flowing through the coils have opposite polarities, and magnetic forces generated in the annular body 11 and directed along the line L₁ (F) can be cancelled out. Since symmetrical currents are made to flow through a pair of coils identical in phase to each other and the directions of the currents are such that the resulting magnetic forces are cancelled out, voltage application with reduced noise such as symmetrical three-line voltage application can be achieved. Additionally, the electric motor 10I can offer the various advantages mentioned in relation to the basic concept described with reference to FIGS. 1A to 1H for the electric motor according to the present invention.

From the foregoing description, numerous modifications and other embodiments of the present disclosure are obvious to those skilled in the art. Accordingly, the foregoing description is to be construed as illustrative only, and is provided for the purpose of teaching those skilled in the art the best mode for carrying out the present invention. The structural and/or functional details may be substantially modified without departing from the scope of the present invention.

The numerals such as ordinal and cardinal numbers as used herein are all given to describe the technology of the present disclosure in concrete terms and not intended to limit the present disclosure. The connection relationships between the elements are used to describe the technology of the present disclosure in concrete terms, and any connection relationships may be employed to achieve the functionality taught in the present disclosure.

### SUMMARY

To solve the problems previously described, an electric motor according to one embodiment of the present invention includes: a first element forming a helix angle with a line extending in a circumferential direction of an annular body, the first element being wound on the annular body without being turned back in the circumferential direction; and a second element located in association with the first element to make an electromagnetic interaction with the first element to generate an electromagnetic force or a magnetic force acting in the circumferential direction of the annular body, wherein one of the first and second elements constitutes at least a part of a stator of the electric motor, and the other of the first and second elements constitutes at least a part of a rotor of the electric motor, the rotor being rotatable by the electromagnetic force or the magnetic force in the circumferential direction of the annular body.

The electric motor having the above configuration can operate with high energy efficiency.

The first element may include a conductive wire, the second element may include a magnetic line source, and the magnetic line source may include a permanent magnet enclosing at least a part of the conductive wire or may include a permanent magnet, an electromagnet, a magnetic body, or an inductor that faces at least a part of the conductive wire.

In the above configuration, the first element generates an electromagnetic force, to which the second element is subjected. The improved way of winding of the first element allows for high energy efficiency regardless of the type of the second element.

The electric motor may be configured as a DC motor that is divisible, and the conductive wire may include a DC winding portion making at least one loop around the annular body in the circumferential direction of the annular body, and a DC voltage application portion located on the DC winding portion to apply a DC voltage to the DC motor.

In the above configuration, the way of winding reduces the proportion of a portion of the DC motor that is not involved in the rotational direction and rotational force, and this allows the DC motor to operate with further enhanced energy efficiency.

The electric motor may be configured as a multi-phase motor that is divisible, and the conductive wire may include a plurality of AC winding portions the number of which is equal to the number of phases of a multi-phase AC voltage applied to the multi-phase motor and which make at least one loop around the annular body in the circumferential direction of the annular body without intersecting each other, and a plurality of AC voltage application portions located in one-to-one correspondence with the plurality of AC winding portions to apply each of the phases of the multi-phase AC voltage to a corresponding one of the plurality of AC winding portions.

In the above configuration, the way of winding reduces the proportion of a phase and a portion of the multi-phase motor that are not involved in the rotational direction and rotational force, and this allows the multi-phase motor to operate as a high-efficiency motor.

The conductive wire may be one of a plurality of conductive wires, and each of the plurality of conductive wires may include a corresponding one of the plurality of AC winding portions.

In the above configuration, the way of winding of the plurality of conductive wires reduces the proportion of a portion of the multi-phase motor that is not involved in the rotational direction and rotational force, and this allows the multi-phase motor to operate with further enhanced energy efficiency.

The conductive wire may be a single conductive wire, and the single conductive wire may include the plurality of AC winding portions.

In the above configuration, the way of winding enables the single conductive wire to form paths for a plurality of phases and reduces the proportion of a portion of the multi-phase motor that is not involved in the rotational direction and rotational force, and this allows the multi-phase motor to operate with further enhanced energy efficiency.

For example, the first element may include a first facing portion facing the second element, the second element may include a second facing portion facing the first element, and the first and second facing portions, as viewed in a direction orthogonal to a thickness direction of the annular body, may have curved shapes conforming to each other.

For example, the first element may include a first facing portion facing the second element, the second element may include a second facing portion facing the first element, and the first and second facing portions, as viewed in a direction orthogonal to a thickness direction of the annular body, may have straight shapes conforming to each other.

The first element may include a permanent magnet, and the second element may include a conductive wire.

In the above configuration, the way of winding without intersection between wound portions allows the permanent magnet to be a long magnet with enhanced efficiency and improved permeance coefficient.

The permanent magnet may include first permanent magnets each of which includes an inner side facing the annular body and an outer side facing away from the annular body and has a north pole on the inner side and a south pole on the outer side, and second permanent magnets each of which includes an inner side facing the annular body and an outer side facing away from the annular body and has a south pole on the inner side and a north pole on the outer side, and the first and second permanent magnets may alternate in the circumferential direction of the annular body.

In the above configuration, the way of winding the magnetic body in association with the coil serving as the second element allows a plurality of alternating north and south poles to be arranged in the rotational direction, i.e., the circumferential direction of the annular body.

The conductive wire may be located inside the permanent magnet and in association with at least a part of the permanent magnet, may form a helix angle with the line extending in the circumferential direction of the annular body, and may be wound on the annular body.

In the above configuration, for example, the influence of a leakage magnetic field can be reduced by locating the coil servings as the second element inside the wound magnetic body serving as the first element.

The first element may include a ferromagnet, the second element may include a ring-shaped body coaxially surrounding the annular body when viewed in an axial direction of the annular body, and the electric motor may further include a conductive wire extending in the circumferential direction of the annular body and wound on the ferromagnet, and a permanent magnet or an electromagnet fixed to the ferromagnet.

In the above configuration, for example, the inclusion of a magnetic line source in the first element wound in the way described above in association with one coil serving as the second element makes it possible to arrange magnetic poles in three patterns by voltage application, the three patterns including a pattern resulting from positive voltage application, a pattern resulting from negative voltage application, and a pattern resulting from no application of voltage.

The ferromagnet may include a first portion that is in contact with or in proximity to the permanent magnet or the electromagnet and that is magnetized as a north pole or a south pole by the permanent magnet or the electromagnet, a second portion extending from the first portion in one direction, forming a helix angle with the line extending in the circumferential direction of the annular body, and wound on one part of the annular body and one part of the conductive wire, a third portion extending from the first portion in another direction opposite to the one direction in which the second portion extends, forming a helix angle with the line extending in the circumferential direction of the annular body, and wound on another part of the annular body and another part of the conductive wire, the ring-shaped body may include a fourth portion facing the annular body and having at least a north pole or a south pole, and upon application of an AC voltage to the conductive wire, the ferromagnet may alternate between: a first magnetized state where an end of the second portion opposite from the first portion is magnetized as a north pole and an end of the third portion opposite from the first portion is more weakly magnetized as a north pole than the end of the second portion opposite from the first portion, or magnetized as a south pole, or not magnetized at all; and a second magnetized state where the end of the second portion opposite from the first portion is magnetized as a south pole and the end of the third portion opposite from the first portion is more weakly magnetized as a south pole than the end of the second portion opposite from the first portion, or magnetized as a north pole, or not magnetized at all.

In the above configuration, for example, the magnetic pole arrangement in the rotational direction of the annular body can be switched between different patterns by switching voltage application to one coil in order from no application of voltage, to positive voltage application, and to negative voltage application, and this enables rotation in the rotational direction of the annular body.

The coil can be an edgewise coil wound in a single layer without overlapping of its different portions and thus can achieve a high occupancy density. This can reduce the influence of the proximity effect. Furthermore, winding the coil thinly in an edgewise fashion can reduce the skin effect, and this enables the electric motor to operate with high energy efficiency.

### Acknowledgment

I would like to take this opportunity to express my special thanks to Tatsuichi Kato, an ex-president of KatoTatsu Tekkosyo, and Sojiro Hagiwara, a former science teacher in a municipal junior high school, to both of whom I owe my filing of this patent application. Applicant and Inventor Shigehiro Hagiwara

### REFERENCE CHARACTER LIST

10A to 10G electric motor
11 annular body
12 circle
13 straight line
14 shaft hole
20 conductive line
21 winding portion
22a first end
22b second end
23a to 23f first to sixth wound portions
24a to 24f front region
25a to 25f back region
26a to 26g extraction portion
30 permanent magnet (first permanent magnet)
32a to 32f magnet segment
40 permanent magnet (second permanent magnet)
42a to 42f magnet segment
102 ferromagnet
110a to 110i ferromagnet segment
111 first portion
112 second portion
130a to 130i permanent magnet
140 conductive wire
150 annular body
152 fourth portion
L₁ line
L₂ central axis

1. An electric motor comprising:
a first element forming a helix angle with a line extending in a circumferential direction of an annular body, the first element being wound on the annular body without being turned back in the circumferential direction; and
a second element located in association with the first element to make an electromagnetic interaction with the first element to generate an electromagnetic force or a magnetic force acting in the circumferential direction of the annular body, wherein
one of the first and second elements constitutes at least a part of a stator of the electric motor, and
the other of the first and second elements constitutes at least a part of a rotor of the electric motor, the rotor being rotatable by the electromagnetic force or the magnetic force in the circumferential direction of the annular body.

2. The electric motor according to claim 1, wherein
the first element includes a conductive wire,
the second element includes a magnetic line source, and
the magnetic line source includes a permanent magnet enclosing at least a part of the conductive wire or includes a permanent magnet, an electromagnet, a magnetic body, or an inductor that faces at least a part of the conductive wire.

3. The electric motor according to claim 2, wherein
the electric motor is configured as a DC motor that is divisible, and
the conductive wire includes
a DC winding portion making at least one loop around the annular body in the circumferential direction of the annular body, and
a DC voltage application portion located on the DC winding portion to apply a DC voltage to the DC motor.

4. The electric motor according to claim 3, wherein
the electric motor is configured as a multi-phase motor that is divisible, and
the conductive wire includes
a plurality of AC winding portions the number of which is equal to the number of phases of a multi-phase AC voltage applied to the multi-phase motor and which make at least one loop around the annular body in the circumferential direction of the annular body without intersecting each other, and
a plurality of AC voltage application portions located in one-to-one correspondence with the plurality of AC winding portions to apply each of the phases of the multi-phase AC voltage to a corresponding one of the plurality of AC winding portions.

5. The electric motor according to claim 4, wherein
the conductive wire is one of a plurality of conductive wires, and
each of the plurality of conductive wires includes a corresponding one of the plurality of AC winding portions.

6. The electric motor according to claim 4, wherein
the conductive wire is a single conductive wire, and
the single conductive wire includes the plurality of AC winding portions.

7. The electric motor according to any one of claims 2 to 6, wherein
the first element includes a first facing portion facing the second element,
the second element includes a second facing portion facing the first element, and
the first and second facing portions, as viewed in a direction orthogonal to a thickness direction of the annular body, have curved shapes conforming to each other.

8. The electric motor according to any one of claims 2 to 6, wherein
the first element includes a first facing portion facing the second element,
the second element includes a second facing portion facing the first element, and
the first and second facing portions, as viewed in a direction orthogonal to a thickness direction of the annular body, have straight shapes conforming to each other.

9. The electric motor according to claim 1, wherein
the first element includes a permanent magnet, and
the second element includes a conductive wire.

10. The electric motor according to claim 9, wherein
the permanent magnet includes
first permanent magnets each of which includes an inner side facing the annular body and an outer side facing away from the annular body and has a north pole on the inner side and a south pole on the outer side, and
second permanent magnets each of which includes an inner side facing the annular body and an outer side facing away from the annular body and has a south pole on the inner side and a north pole on the outer side, and
the first and second permanent magnets alternate in the circumferential direction of the annular body.

11. The electric motor according to claim 9 or 10, wherein
the conductive wire is located inside the permanent magnet and in association with at least a part of the permanent magnet, forms a helix angle with the line extending in the circumferential direction of the annular body, and is wound on the annular body.

12. The electric motor according to claim 1, wherein
the first element includes a ferromagnet,
the second element includes a ring-shaped body coaxially surrounding the annular body when viewed in an axial direction of the annular body, and
the electric motor further comprises
a conductive wire extending in the circumferential direction of the annular body and wound on the ferromagnet, and
a permanent magnet or an electromagnet fixed to the ferromagnet.

13. The electric motor according to claim 12, wherein
the ferromagnet includes
a first portion that is in contact with or in proximity to the permanent magnet or the electromagnet and that is magnetized as a north pole or a south pole by the permanent magnet or the electromagnet,
a second portion extending from the first portion in one direction, forming a helix angle with the line extending in the circumferential direction of the annular body, and wound on one part of the annular body and one part of the conductive wire,
a third portion extending from the first portion in another direction opposite to the one direction in which the second portion extends, forming a helix angle with the line extending in the circumferential direction of the annular body, and wound on another part of the annular body and another part of the conductive wire,
the ring-shaped body includes a fourth portion facing the annular body and having at least a north pole or a south pole, and
upon application of an AC voltage to the conductive wire, the ferromagnet alternates between: a first magnetized state where an end of the second portion opposite from the first portion is magnetized as a north pole and an end of the third portion opposite from the first portion is more weakly magnetized as a north pole than the end of the second portion opposite from the first portion, or magnetized as a south pole, or not magnetized at all; and a second magnetized state where the end of the second portion opposite from the first portion is magnetized as a south pole and the end of the third portion opposite from the first portion is more weakly magnetized as a south pole than the end of the second portion opposite from the first portion, or magnetized as a north pole, or not magnetized at all.
